(19) United States
(12) Patent Application Publication
(10) Pub. No.: US 2025/0240492 A1
(43) Pub. Date: Jul. 24, 2025

(54) DATA PROCESSING

(71) Applicant: Tencent Technology (Shenzhen) Company Limited, Shenzhen (CN)

(72) Inventors: Yang CUI, Shenzhen (CN); Tao XIE, Shenzhen (CN); Yunying LIU, Shenzhen (CN)

(73) Assignee: Tencent Technology (Shenzhen) Company Limited, Shenzhen (CN)

(21) Appl. No.: 19/173,683

(22) Filed: Apr. 8, 2025

Related U.S. Application Data
(63) Continuation of application No. PCT/CN2024/080384, filed on Mar. 6, 2024.

(30) Foreign Application Priority Data
Apr. 16, 2023 (CN) 202310456084.9

(51) Int. Cl. H04N 21/482; H04N 21/266; H04N 21/431; H04N 21/4627; H04N 21/472; H04N 21/81

(52) U.S. Cl. CPC H04N 21/482; H04N 21/266; H04N 21/4312; H04N 21/4627; H04N 21/472; H04N 21/8166

(57) ABSTRACT

In a method for data processing, when media data and a user viewing the media data simultaneously satisfy a media reference condition, a media reference control is displayed in a media interaction platform configured to display the media data and different from a subprogram platform configured to maintain a subprogram. A subprogram selection list associated with the user is displayed in the media interaction platform based on a trigger operation on the media reference control. An external credential for the media data that is configured for the user to reference the media data to a target subprogram that has permission to display the media data is obtained based on a user performing a confirmation operation with the subprogram selection list.

### RELATED APPLICATIONS

The present application is a continuation of International Application No. PCT/CN2024/080384, filed on Mar. 6, 2024, which claims priority to Chinese Patent Application No. 202310456084.9, filed on Apr. 16, 2023. The entire disclosures of the prior applications are hereby incorporated by reference.

### FIELD OF THE TECHNOLOGY

This disclosure relates to the technical field of Internet including a data processing method and apparatus, a computer device, and a readable storage medium.

### BACKGROUND OF THE DISCLOSURE

When a subprogram development object and a publishing object publishing media data (for example, video data) are the same subject object, the subprogram development object may directly acquire, when developing a subprogram (for example, a target subprogram), media data published by the subprogram development object in a media interaction platform, and reference (i.e., embed) the media data to the target subprogram through the subprogram platform. However, when the subprogram development object and the publishing object are different subject objects, the subprogram development object may not acquire the media data published by the publishing object in the media interaction platform, and then may not reference the media data published by the publishing object in the media interaction platform to the target subprogram. Consequently, the media data may not be presented in the target subprogram, thereby reducing the capability of circulating, in the subprogram, the media data in the media interaction platform.

### SUMMARY

Embodiments of this disclosure include a data processing method and apparatus, a computer device, and a readable storage medium, which may improve the capability of circulating, in a subprogram, media data in a media interaction platform.

Technical solutions of embodiments of this disclosure may be implemented as follows.

An embodiment of this disclosure provides a data processing method. In the method, when media data and a user viewing the media data simultaneously satisfy a media reference condition, a media reference control is displayed in a media interaction platform configured to display the media data and different from a subprogram platform configured to maintain a subprogram. A subprogram selection list associated with the user is displayed in the media interaction platform based on a trigger operation on the media reference control. An external credential for the media data that is configured for the user to reference the media data to a target subprogram that has permission to display the media data is obtained based on the user performing a confirmation operation with the subprogram selection.

An embodiment of this disclosure provides a data processing apparatus. The apparatus includes processing circuitry that is configured to display, when media data and a user viewing the media data simultaneously satisfy a media reference condition, a media reference control in a media interaction platform configured to display the media data and different from a subprogram platform configured to maintain a subprogram, display, in the media interaction platform, a subprogram selection list associated with the user based on a trigger operation on the media reference control, and obtain, based on the user performing a confirmation operation with the subprogram selection list, an external credential for the media data that is configured for the user to reference the media data to a target subprogram that has permission to display the media data.

An embodiment of this disclosure provides a device, including a memory and a processor. The memory is configured to store executable instructions. The processor is configured to implement, when executing the executable instructions stored in the memory, the method for data processing provided in embodiments of this disclosure.

An embodiment of this disclosure provides a non-transitory computer-readable storage medium, storing instructions which when executed by a processor cause the processor to perform the method for data processing provided in embodiments of this disclosure.

An embodiment of this disclosure provides a computer program product, including a computer program or computer-executable instructions. When the computer program or the computer-executable instructions are executed by a processor, the method for data processing provided in embodiments of this disclosure is implemented.

In this embodiment of this disclosure, the computer device may display, when the media data and the subprogram development object viewing the media data simultaneously satisfy the media reference condition, the media reference control in the media interaction platform configured for displaying the media data, and further display, in the media interaction platform, the subprogram selection list associated with the subprogram development object in response to the trigger operation for the media reference control. The computer device may acquire, in response to the confirmation operation for the subprogram selection list, the external credential for the media data. The external credential is configured for instructing the subprogram development object to reference the media data to the target subprogram, and the target subprogram referencing the media data has permission to display the media data. The target subprogram is a subprogram obtained by the subprogram development object performing the confirmation operation on the subprogram selection list. It can be seen that, regardless of whether the subprogram development object and the publishing object publishing the media data are the same subject object, as long as the media data and the subprogram development object simultaneously satisfy the media reference condition, the subprogram development object may acquire, based on the media reference control, the external credential configured for referencing the media data to the target subprogram, and reference the media data in the target subprogram based on the external credential, to display the media data in the target subprogram referencing the media data (that is, the media data may be referenced to the subprogram of the subprogram development object without limitation to a subject), thereby presenting the media data in the target subprogram, and improving the capability of circulating, in the subprogram, the media data in the media interaction platform.

### BRIEF DESCRIPTION OF THE DRAWINGS

FIG. 1 is a schematic structural diagram of a network architecture according to an embodiment of this disclosure.

FIG. 2 is a schematic diagram of a scene for performing data interaction according to an embodiment of this disclosure.

FIG. 3 is a schematic flowchart of a data processing method according to an embodiment of this disclosure.

FIG. 4 is a schematic diagram of a scene for displaying a media reference control according to an embodiment of this disclosure.

FIG. 5a is a schematic diagram of a scene for selecting a target subprogram according to an embodiment of this disclosure.

FIG. 5b is a schematic diagram of a scene for selecting a target subprogram according to an embodiment of this disclosure.

FIG. 6 is a schematic diagram of a scene for triggering a media reference controlling control according to an embodiment of this disclosure.

FIG. 7 is a schematic diagram of a scene for triggering a subprogram reference controlling control according to an embodiment of this disclosure.

FIG. 8 is a schematic flowchart of referencing media data according to an embodiment of this disclosure.

FIG. 9 is a schematic flowchart of a data processing method according to an embodiment of this disclosure.

FIG. 10 is a schematic diagram of a scene for pushing a media reference notification according to an embodiment of this disclosure.

FIG. 11 is a schematic flowchart of a data processing method according to an embodiment of this disclosure.

FIG. 12a is a schematic diagram of a scene for viewing a target subprogram according to an embodiment of this disclosure.

FIG. 12b is a schematic diagram of a scene for viewing a target subprogram according to an embodiment of this disclosure.

FIG. 13 is a schematic flowchart of a data processing method according to an embodiment of this disclosure.

FIG. 14 is a schematic flowchart of copying an external credential according to an embodiment of this disclosure.

FIG. 15 is a schematic flowchart of a data processing method according to an embodiment of this disclosure.

FIG. 16 is a schematic flowchart of redeeming an external credential according to an embodiment of this disclosure.

FIG. 17 is a schematic structural diagram of a data processing apparatus according to an embodiment of this disclosure.

FIG. 18 is a schematic structural diagram of a data processing apparatus according to an embodiment of this disclosure.

FIG. 19 is a schematic structural diagram of a computer device according to an embodiment of this disclosure.

### DESCRIPTION OF EMBODIMENTS

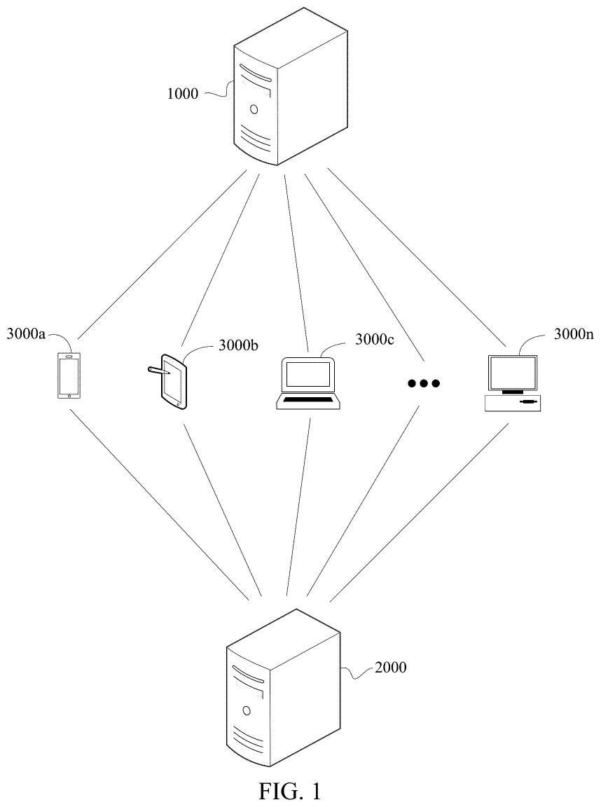

Specifically, FIG. 1 is a schematic structural diagram of a network architecture according to an embodiment of this disclosure. As shown in FIG. 1, the network architecture may include a subprogram server 1000, a media server 2000, and a terminal device cluster. The terminal device cluster may specifically include one or more terminal devices, and the number of terminal devices in the terminal device cluster is not limited herein. As shown in FIG. 1, a plurality of terminal devices may specifically include a terminal device 3000a, a terminal device 3000b, a terminal device 3000c, . . . , and a terminal device 3000n. The terminal device 3000a, the terminal device 3000b, the terminal device 3000c, . . . , and the terminal device 3000n may separately have a direct or indirect network connection to the subprogram server 1000 in a wired or wireless communication manner so that each terminal device may perform data interaction with the subprogram server 1000 through the network connection. The terminal device 3000a, the terminal device 3000b, the terminal device 3000c, . . . , and the terminal device 3000n may separately have a direct or indirect network connection to the media server 2000 in a wired or wireless communication manner so that each terminal device may perform data interaction with the media server 2000 through the network connection.

Each terminal device in the terminal device cluster may include: a smart terminal with a data processing function, such as a smartphone, a tablet computer, a notebook computer, a desktop computer, an intelligent voice interaction device, an intelligent appliance (such as a smart television), a wearable device, an in-vehicle terminal, and an aircraft. The in-vehicle terminal may be a terminal device in a smart traffic scene or an assisted driving scene. Each terminal device in the terminal device cluster shown in FIG. 1 may be installed with an application client. The application client may specifically include a client with a data processing function, such as an in-vehicle client, a smart home client, an entertainment client (for example, a game client), a multimedia client (for example, a video client), a social client, a management client, and an information client (for example, a news client).

For ease of understanding, in this embodiment of this disclosure, one terminal device may be selected from the plurality of terminal devices shown in FIG. 1 as a target terminal device. For example, in this embodiment of this disclosure, the terminal device 3000a shown in FIG. 1 may be used as the target terminal device, and the target terminal device may be installed with an application client. The application client in the target terminal device may include a first application client and a second application client.

The first application client may be configured to integrate a subprogram (for example, a target subprogram) and a media interaction platform (for example, a video interaction platform). In this case, the subprogram and the media interaction platform may be started using the first application client. In some embodiments, the media interaction platform may alternatively be referred to as a subprogram in the first application client. For ease of understanding, this embodiment of this disclosure is described using an example in which the subprogram is a subprogram in the first application client except the media interaction platform. The first application client may alternatively be referred to as a host application configured to integrate the subprogram and the media interaction platform. The host application may be configured to represent an application subject providing a running environment for the subprogram and the media interaction platform. For example, an example in which the host application running in the target terminal device is a social client is used. When the target subprogram and the video interaction platform (for example, a video account) are integrated in the social client, the social client may have a capability of turning on and presenting the target subprogram and the video interaction platform.

The subprogram in this embodiment of this application may be a mini program (for example, a target mini program) integrated in the first application client. In this case, the mini program is a subprogram integrated in the first application client, the subprogram server may be a mini program server corresponding to the mini program, a subprogram development object may be a mini program development object corresponding to the mini program, and a subprogram platform may be a mini program platform corresponding to the mini program. In some embodiments, the subprogram in this embodiment of this disclosure may alternatively be another subprogram integrated in the first application client except the mini program, for example, a shopping platform or an official account integrated in the first application client.

The second application client may be a subprogram platform configured to maintain a subprogram in the first application client. The second application client may be integrated in a client (for example, a social client), or may be an independent client (for example, a management client). A type of the second application client is not limited in this embodiment of this disclosure.

When running in the target terminal device, the subprogram may perform data interaction with the subprogram server 1000 shown in FIG. 1 (that is, the target terminal device may perform data interaction with the subprogram server 1000 through the subprogram integrated in the first application client). Similarly, when running in the target terminal device, the second application client may perform data interaction with the subprogram server 1000 shown in FIG. 1 (that is, the target terminal device may perform data interaction with the subprogram server 1000 through the second application client). The subprogram server 1000 may be an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

When running in the target terminal device, the media interaction platform may perform data interaction with the media server 2000 shown in FIG. 1 (that is, the target terminal device may perform data interaction with the media server 2000 through the media interaction platform integrated in the first application client). The media server 2000 may be an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a CDN, and a big data and artificial intelligence platform.

For ease of understanding, in this embodiment of this disclosure, the user may be referred to as an object, and the object may be a user that logs in to the first application client and the second application client. In this embodiment of this disclosure, an object that logs in to the first application client may be referred to as an interaction object (that is, an object that logs in to the subprogram and the media interaction platform may be referred to as an interaction object), and an interaction object that publishes media data in the media interaction platform may be referred to as a publishing object. In this embodiment of this disclosure, an object that logs in to the second application client (i.e., the subprogram platform) may be referred to as a subprogram development object.

The media interaction platform may have an administrator (that is, an administrator may manage an account of the administrator through the media interaction platform), and the administrator of the media interaction platform may be referred to as a publishing object. The subprogram platform may have one administrator and a plurality of developers (that is, one administrator and a plurality of developers may manage the same subprogram through the subprogram platform, that is, one administrator and a plurality of developers may log in to the subprogram platform using respective accounts to manage the same subprogram). The administrator or developer of the subprogram platform may be referred to as a subprogram development object.

The media data in this embodiment of this disclosure may include, but is not limited to, video data, graphic and textual data, and audio data. In this case, the media interaction platform may include, but is not limited to, a video interaction platform corresponding to the video data, a graphic and textual interaction platform corresponding to the graphic and textual data, and an audio interaction platform corresponding to the audio data. The media server 2000 may include, but is not limited to, a video server corresponding to the video interaction platform, a graphic and textual server corresponding to the graphic and textual interaction platform, and an audio server corresponding to the audio interaction platform. For ease of understanding, this embodiment of this disclosure is described using an example in which the media data is video data, the media interaction platform is a video interaction platform, and the media server is a video server.

A data processing method provided by the embodiments of this disclosure may be performed by a computer device, and the computer device may acquire an external credential for media data through cloud technology. For ease of understanding, this embodiment of this disclosure is described using an example in which interaction objects logging in to the subprogram (for example, the target subprogram) and the media interaction platform are subprogram development objects. Therefore, the subprogram development object may view, in the media interaction platform, the media data published by the publishing object, acquire the external credential for the media data, write the external credential into subprogram code of the target subprogram, and then publish the subprogram code in the subprogram platform to obtain the target subprogram referencing the media data (that is, the media data is referenced to the target subprogram). The target subprogram referencing the media data has permission to display the media data. Further, the subprogram development object may log in to the target subprogram referencing the media data and display the media data in the target subprogram referencing the media data, thereby expanding a reference range and capability of the subprogram for the media interaction platform, increasing a distribution scene of the media data, and further enabling the presentation of the media data of the subprogram to have a better carrier.

For example, the publishing object may be a video blogger, and the target subprogram may be a subprogram of a cosmetics brand owner. When the video blogger collaborates with the cosmetics brand owner, a terminal device corresponding to the video blogger may acquire media data (for example, video data) made by the video blogger for the cosmetics brand owner, and publish the video data on a video account (i.e., a video interaction platform) of the video blogger. In this way, a terminal device corresponding to the cosmetic brand owner may introduce the video data to the target subprogram based on an external credential, thereby promoting the collaboration between the video blogger and the cosmetic brand owner. For another example, the publishing object may be a video editing company, and the target subprogram may be a subprogram of a sportswear enterprise. When the video editing company collaborates with the sportswear enterprise, a terminal device corresponding to the video editing company may acquire video data (i.e., a promotional video) shot by the video editing company for the sportswear enterprise, and publish the promotional video on a video account (i.e., a video interaction platform) of the video editing company. In this way, a terminal device corresponding to the sportswear enterprise may introduce the promotional video to the target subprogram based on an external credential, thereby promoting the collaboration between the video editing company and the sportswear enterprise.

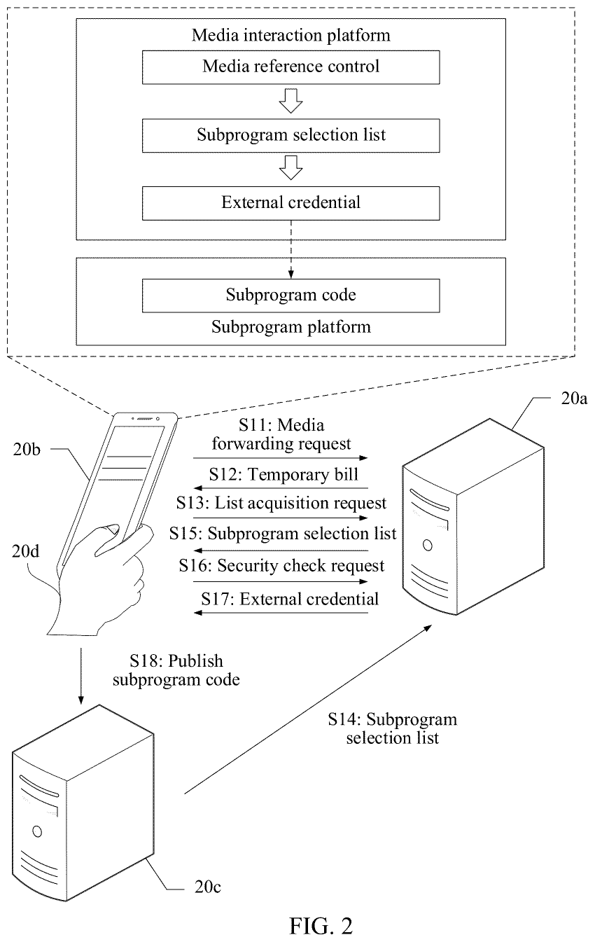

For ease of understanding, further, FIG. 2 is a schematic diagram of a scene for performing data interaction according to an embodiment of this disclosure. A media server 20a shown in FIG. 2 may be the media server 2000 in the foregoing embodiment corresponding to FIG. 1, a subprogram server 20c shown in FIG. 2 may be the subprogram server 1000 in the foregoing embodiment corresponding to FIG. 1, and a terminal device 20b shown in FIG. 2 may be the target terminal device in the foregoing embodiment corresponding to FIG. 1. An object corresponding to the terminal device 20b may be a subprogram development object 20d.

The terminal device 20b may include a media interaction platform configured for displaying media data and a subprogram platform configured for maintaining a subprogram. The media interaction platform configured for displaying the media data is different from the subprogram platform configured for maintaining the subprogram. A subprogram development object 20d may log in to the media interaction platform and the subprogram platform through the terminal device 20b. The same account is used when the subprogram development object 20d logs in to the media interaction platform and the subprogram platform.

As shown in FIG. 2, the subprogram development object 20d may view the media data through the media interaction platform. When the subprogram development object 20d needs to acquire an external credential for the media data, the subprogram development object 20d may perform a trigger operation on a media forwarding control in the media interaction platform. In this way, the terminal device 20b may transmit, in response to the trigger operation performed by the subprogram development object 20d on the media forwarding control, a media forwarding request to the media server 20a through operation S11. Further, after receiving the media forwarding request transmitted by the media interaction platform in the terminal device 20b, the media server 20a may perform condition analysis on a development object identifier and a media identifier to obtain a condition analysis result, then generate a temporary bill when the condition analysis result indicates that the media data and the subprogram development object simultaneously satisfy a media reference condition, and transmit the temporary bill to the media interaction platform in the terminal device 20b through operation S12.

As shown in FIG. 2, the terminal device 20b may receive the temporary bill transmitted by the media server 20a and display a media reference control in the media interaction platform based on the temporary bill. Further, the subprogram development object 20d may perform a trigger operation on the media reference control. In this way, the terminal device 20b may transmit, in response to the trigger operation performed by the subprogram development object 20d on the media reference control, a list acquisition request to the media server 20a through operation S13. Further, after receiving the list acquisition request transmitted by the media interaction platform in the terminal device 20b, the media server 20a may acquire a subprogram selection list associated with the subprogram development object from the subprogram server 20c through operation S14, and then return the subprogram selection list to the media interaction platform in the terminal device 20b through operation S15.

As shown in FIG. 2, the terminal device 20b may receive the subprogram selection list returned by the media server 20a and display the subprogram selection list in the media interaction platform. Further, the subprogram development object 20d may perform a confirmation operation on the subprogram selection list. In this way, the terminal device 20b may transmit, in response to the confirmation operation performed by the subprogram development object 20d on the subprogram selection list, a security check request to the media server 20a through operation S16. Further, after receiving the security check request transmitted by the media interaction platform in the terminal device 20b, the media server 20a may perform a security check on the development object identifier and the temporary bill to obtain a security check result, generate an external credential for the media data when the security check result indicates that the security check succeeds, and transmit the external credential to the media interaction platform in the terminal device 20b through operation S17.

As shown in FIG. 2, the terminal device 20b may receive the external credential transmitted by the media server 20a. Further, the subprogram development object 20d may copy and paste the external credential to subprogram code corresponding to the target subprogram to perform a publishing operation on the subprogram code in the subprogram platform (that is, publishing the subprogram code in the subprogram platform). In this way, the terminal device 20b may transmit, in response to the publishing operation performed by the subprogram development object 20d on the subprogram code, the subprogram code to the subprogram server 20c through operation S18. The target subprogram may be a subprogram selected by the subprogram development object 20d from a subprogram list, that is, the external credential is generated for the media data and the target subprogram.

Further, after receiving the subprogram code transmitted by the subprogram platform in the terminal device 20b, the subprogram server 20c may perform program compiling on the subprogram code to obtain the target subprogram referencing the media data. In some embodiments, the subprogram platform in the terminal device 20b may perform program compiling on the subprogram code to obtain the target subprogram referencing the media data. In other words, the external credential may be configured for instructing the subprogram development object to reference the media data to the target subprogram to obtain the target subprogram referencing the media data, and the target subprogram referencing the media data has permission to display the media data. The target subprogram referencing the media data may alternatively be referred to as a target subprogram.

Therefore, when an interaction object (for example, the subprogram development object 20d) uses the target subprogram referencing the media data through the terminal device 20b, the interaction object may view the media data through the target subprogram referencing the media data, and does not need to view the media data through the media interaction platform so that the media data in the media interaction platform may be propagated in the target subprogram referencing the media data, thereby improving the propagation ability of the media data.

It can be seen that in this embodiment of this disclosure, the external credential for the media data may be acquired through the media interaction platform when the media data and the subprogram development object simultaneously satisfy the media reference condition. Regardless of whether the subprogram development object and the publishing object publishing the media data are the same subject object, in this embodiment of this disclosure, the external credential for the media data may be acquired, and the external credential may be configured for introducing the media data to the target subprogram developed by the subprogram development object, thereby improving the capability of circulating the media data in the subprogram. In addition, the security of referencing the media data may be improved by determining whether the media data and the subprogram development object simultaneously satisfy the media reference condition.

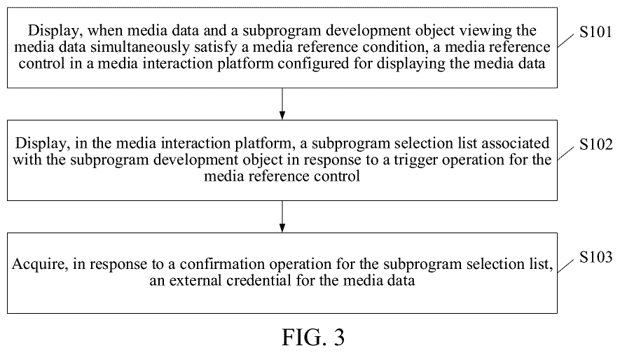

Further, FIG. 3 is a schematic flowchart of a data processing method according to an embodiment of this disclosure. The method may be performed by a media server, by a terminal device, or by the media server and the terminal device. The media server may be the media server 20a in the foregoing embodiment corresponding to FIG. 2, and the terminal device may be the terminal device 20b in the foregoing embodiment corresponding to FIG. 2. For ease of understanding, this embodiment of this disclosure is described using an example in which the method is performed by the terminal device. The data processing method may include the following operation S101 to operation S103.

Operation S101: Display, when media data and a subprogram development object viewing the media data simultaneously satisfy a media reference condition, a media reference control in a media interaction platform configured for displaying the media data. In an example, when media data and a user viewing the media data simultaneously satisfy a media reference condition, a media reference control is displayed in a media interaction platform configured to display the media data and different from a subprogram platform configured to maintain a subprogram.

Specifically, the terminal device may display the media data in the media interaction platform. The media interaction platform includes a media forwarding control. Further, the terminal device may display, in response to a trigger operation for the media forwarding control, the media reference control in the media interaction platform when the media data and the subprogram development object viewing the media data simultaneously satisfy the media reference condition. The media interaction platform is different from a subprogram platform configured for maintaining a subprogram.

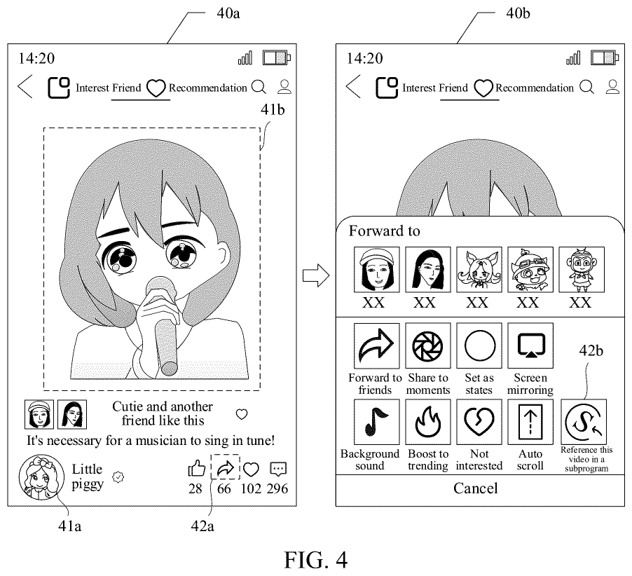

For ease of understanding, FIG. 4 is a schematic diagram of a scene for displaying a media reference control according to an embodiment of this disclosure. A media viewing interface 40a and a media viewing interface 40b shown in FIG. 4 may be interfaces of a media interaction platform at different moments. A terminal device may display media data (for example, playing video data published by a publishing object 41a) in the media viewing interface 40a and the media viewing interface 40b of the media interaction platform. The media viewing interface 40a may include a media forwarding control 42a.

As shown in FIG. 4, a subprogram development object may perform a trigger operation on the media forwarding control 42a. In this way, in response to the trigger operation performed by the subprogram development object on the media forwarding control 42a, when the media data and the subprogram development object simultaneously satisfy a media reference condition, the terminal device may switch the media viewing interface 40a to the media viewing interface 40b and display a media reference control 42b in the media viewing interface 40b. In some embodiments, when the media data and the subprogram development object do not satisfy the media reference condition, the terminal device does not need to display the media reference control 42b in the media viewing interface 40b.

Operation S102: Display, in the media interaction platform, a subprogram selection list associated with the subprogram development object in response to a trigger operation for the media reference control. In an example, a subprogram selection list associated with the user is displayed in the media interaction platform based on a trigger operation for the media reference control.

Specifically, the terminal device may acquire, in response to the trigger operation for the media reference control, subprograms associated with the subprogram development object (i.e., acquiring subprograms developed by the subprogram development object). Further, the terminal device may determine, when there is one subprogram associated with the subprogram development object, the subprogram associated with the subprogram development object as the target subprogram and display, in the media interaction platform, the subprogram selection list associated with the subprogram development object. The subprogram selection list contains the target subprogram in a default selected state, that is, the subprogram selection list contains the target subprogram in a selected state.

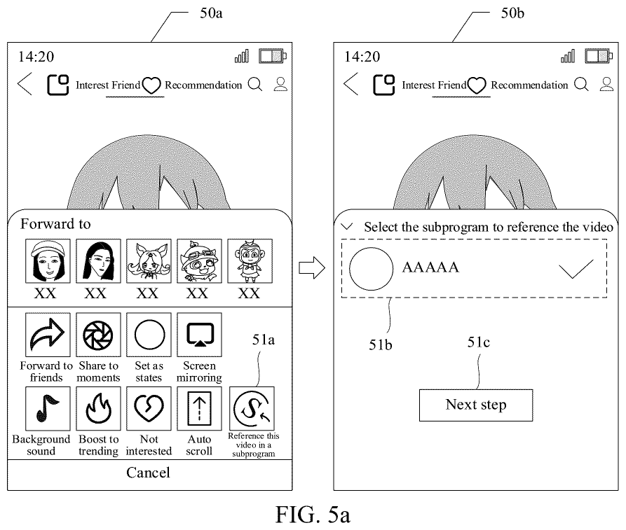

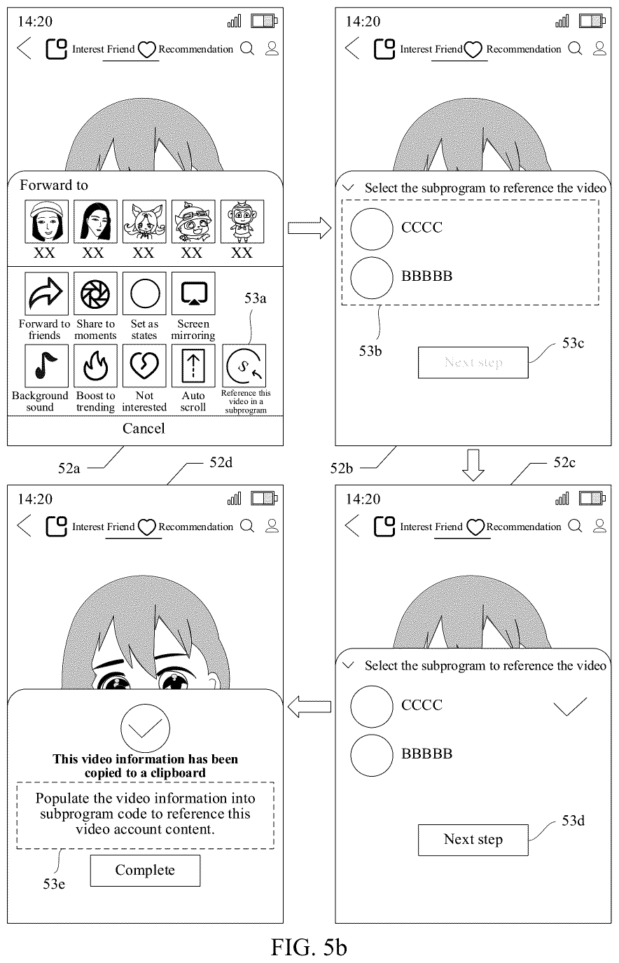

For ease of understanding, FIG. 5a is a schematic diagram of a scene for selecting a target subprogram according to an embodiment of this disclosure. A media viewing interface 50a and a media viewing interface 50b shown in FIG. 5a may be interfaces of a media interaction platform at different moments, and the media viewing interface 50a may be the media viewing interface 40b in the foregoing embodiment corresponding to FIG. 4. The media viewing interface 50a may include a media reference control 51a.

As shown in FIG. 5a, a subprogram development object may perform a trigger operation on the media reference control 51a. In this way, the terminal device may acquire, in response to the trigger operation performed by the subprogram development object on the media reference control 51a, subprograms associated with the subprogram development object, switch the media viewing interface 50a to the media viewing interface 50b, and display, in the media viewing interface 50b, a subprogram selection list 51b associated with the subprogram development object. The subprogram selection list 51b may include the subprograms associated with the subprogram development object. When there is one subprogram associated with the subprogram development object, the terminal device may determine the subprogram (for example, a subprogram “AAAAA”) associated with the subprogram development object as the target subprogram, and display the target subprogram in a default selected state in the media viewing interface 50b.

In some embodiments, the terminal device may acquire, in response to the trigger operation for the media reference control, subprograms associated with the subprogram development object (i.e., acquiring subprograms developed by the subprogram development object). Further, the terminal device may display, in the media interaction platform, the subprogram selection list associated with the subprogram development object when there are a plurality of subprograms associated with the subprogram development object. The subprogram selection list contains the plurality of subprograms in an unselected state.

For ease of understanding, FIG. 5b is a schematic diagram of a scene for selecting a target subprogram according to an embodiment of this disclosure. A media viewing interface 52a, a media viewing interface 52b, a media viewing interface 52c, and a media viewing interface 52d shown in FIG. 5b may be interfaces of a media interaction platform at different moments, and the media viewing interface 52a may be the media viewing interface 40b in the foregoing embodiment corresponding to FIG. 4. The media viewing interface 52a may include a media reference control 53a.

As shown in FIG. 5b, a subprogram development object may perform a trigger operation on the media reference control 53a. In this way, the terminal device may acquire, in response to the trigger operation performed by the subprogram development object on the media reference control 53a, subprograms associated with the subprogram development object, switch the media viewing interface 52a to the media viewing interface 52b, and display, in the media viewing interface 52b, a subprogram selection list 53b associated with the subprogram development object. The subprogram selection list 53b may include the subprograms associated with the subprogram development object. When there are a plurality of (for example, two) subprograms associated with the subprogram development object, the terminal device may display the plurality of subprograms (for example, a subprogram “CCCC” and a subprogram “BBBB”) in an unselected state in the media viewing interface 52b.

In some embodiments, the terminal device may further directly display the media reference control in the media interaction platform when the media data and the subprogram development object viewing the media data simultaneously satisfy the media reference condition while displaying the media data in the media interaction platform without displaying a media forwarding control in the media interaction platform.

Operation S103: Acquire, in response to a confirmation operation for the subprogram selection list, an external credential for the media data. In an example, an external credential for the media data that is configured for the user to reference the media data to a target subprogram that has permission to display the media data is obtained based on a user performing a confirmation operation with the subprogram selection list.

Specifically, the terminal device may display, in the media interaction platform, a selection confirmation control for the target subprogram when there is one subprogram associated with the subprogram development object. The target subprogram is a subprogram obtained by the subprogram development object performing the confirmation operation on the subprogram selection list. Further, the terminal device may acquire, in response to a trigger operation for the selection confirmation control, the external credential for the media data. Further, the terminal device may copy the external credential and display reference prompt information in the media interaction platform based on the external credential. The external credential is configured for instructing the subprogram development object to reference the media data to the target subprogram, and the target subprogram referencing the media data has permission to display the media data. That is, the external credential is published to the subprogram development object only when the subprogram development object and the media data satisfy the reference condition. In this way, publishing of the external credential to a subprogram development object that does not satisfy the reference condition may be avoided so that the security of referencing the media data may be improved, and the ecological abuse of the media data in the media interaction platform by the target subprogram may be avoided.

For ease of understanding, FIG. 5a is referred to again. As shown in FIG. 5a, the terminal device may display a selection confirmation control 51c for the target subprogram in the media viewing interface 50b. A control state of the selection confirmation control 51c is a selectable state, and the subprogram development object may perform a trigger operation on the selection confirmation control 51c. A specific process in which the terminal device responds to the trigger operation performed by the subprogram development object on the selection confirmation control 51c may refer to the description of responding to a trigger operation performed by the subprogram development object on a selection confirmation control 53d in the embodiment corresponding to FIG. 5b.

In some embodiments, when there are a plurality of subprograms associated with the subprogram development object, the terminal device may determine, in response to a selection operation for the plurality of subprograms in the unselected state in the subprogram selection list, a subprogram selected by the selection operation as the target subprogram (that is, the target subprogram is a subprogram selected by the subprogram development object from the subprogram selection list), and update and display the target subprogram in the subprogram selection list from the unselected state to a selected state (that is, the target subprogram in the unselected state is updated to the target subprogram in the selected state). Further, the terminal device may display a selection confirmation control for the target subprogram in the selected state, that is, the selection confirmation control is updated and displayed from an unselectable state to the selectable state (that is, the selection confirmation control in the unselectable state is updated to a selection confirmation control in the selectable state). The unselectable state represents that a trigger operation may not be performed on the selection confirmation control, and the selectable state represents that a trigger operation may be performed on the selection confirmation control. Further, the terminal device may acquire, in response to a trigger operation for the selection confirmation control, the external credential for the media data. Further, the terminal device may copy the external credential and display reference prompt information in the media interaction platform based on the external credential. The reference prompt information is configured for prompting that the media data is referenced to the target subprogram based on the copied external credential. That is, a pasting operation may be subsequently performed on the copied external credential to reference the media data to the target subprogram. The external credential is configured for instructing the subprogram development object to reference the media data to the target subprogram, and the target subprogram referencing the media data has permission to display the media data.

For ease of understanding, FIG. 5b is referred to again. As shown in FIG. 5b, the terminal device may display a selection confirmation control 53c in the media viewing interface 52b. A control state of the selection confirmation control 53c is an unselectable state, and the subprogram development object cannot perform a trigger operation on the selection confirmation control 53c in the unselectable state. Further, the subprogram development object may perform a selection operation on the plurality of subprograms in the unselected state in the subprogram selection list 53b (for example, the subprogram development object may perform a selection operation on the subprogram “CCCC”). In this way, the terminal device may determine, in response to the selection operation performed by the subprogram development object on the subprogram “CCCC”, the subprogram “CCCC” selected by the selection operation as the target subprogram, switch the media viewing interface 52b to the media viewing interface 52c, update and display the target subprogram from the unselected state to the selected state in the media viewing interface 52c, and display the selection confirmation control 53d in the media viewing interface 52c. A control state of the selection confirmation control 53d is a selectable state (that is, the selection confirmation control 53c in the unselectable state is updated to a selection confirmation control 53d in the selectable state).

As shown in FIG. 5b, the subprogram development object may perform a trigger operation on the selection confirmation control 53d. In this way, the terminal device may, in response to the trigger operation performed by the subprogram development object on the selection confirmation control 53d, acquire and copy the external credential for the media data, switch the media viewing interface 52c to the media viewing interface 52d, and display reference prompt information 53e in the media viewing interface 52d. For example, the reference prompt information 53e may be “populate the video information into subprogram code to reference this video account content”. The reference prompt information 53e may further include “this video information has been copied to a clipboard”, that is, the copied video information is a copied external credential of the media data.

The terminal device may display, in the subprogram platform, media reference description information and a media reference controlling control corresponding to the media reference description information. A control state of the media reference controlling control is an off state. Further, the terminal device may, in response to a trigger operation for the media reference controlling control, update and display the media reference controlling control from the off state to an on state (that is, the media reference controlling control in the off state is updated to a media reference controlling control in the on state). The media reference controlling control in the on state is configured to indicate that the subprogram development object satisfies the media reference condition. Further, when a default time period is reached, the terminal device may update and display the media reference controlling control from the on state to the off state again (that is, the media reference controlling control in the on state is updated to the media reference controlling control in the off state). In other words, the media reference controlling control that is turned on may be automatically turned off after the default time period.

A specific period duration of the default time period is not limited in this embodiment of this disclosure. For example, the default time period may be 24 hours or 12 hours. For ease of understanding, this embodiment of this disclosure is described using an example in which the specific period duration of the default time period is 24 hours.

Similarly, the terminal device may display, in the subprogram platform, the media reference description information and the media reference controlling control corresponding to the media reference description information. The control state of the media reference controlling control is the on state. Further, the terminal device may, in response to the trigger operation for the media reference controlling control, update and display the media reference controlling control from the on state to the off state (that is, the media reference controlling control in the on state is updated to the media reference controlling control in the off state). The media reference controlling control in the off state is configured for indicating that the subprogram development object does not satisfy the media reference condition.

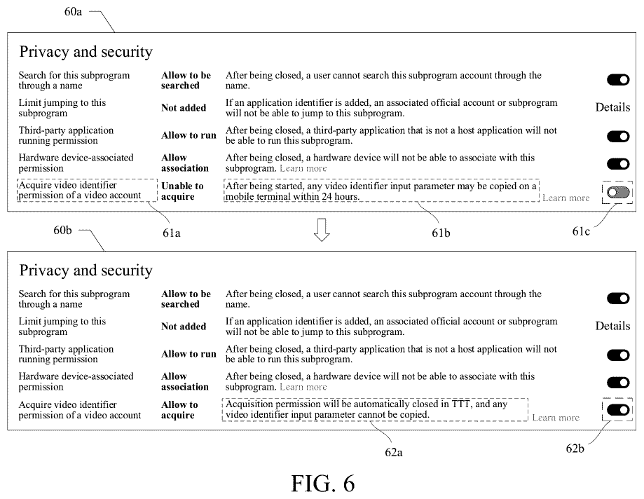

For ease of understanding, FIG. 6 is a schematic diagram of a scene for triggering a media reference controlling control according to an embodiment of this disclosure. A subprogram management page 60a and a subprogram management page 60b shown in FIG. 6 may be pages of a subprogram platform at different moments. The subprogram management page 60a may include media reference description information and a media reference controlling control 61c, and a control state of the media reference controlling control 61c is an off state. The media reference description information may include media reference description information 61a and media reference description information 61b. The media reference description information 61a may be a description title, and the media reference description information 61b may be description content. For example, the media reference description information 61b may be “after being started, any video identifier input parameter may be copied on a mobile terminal within 24 hours” and “after being started, any video account video identifier input parameter may be copied on a mobile terminal within 24 hours, which is effective only for a current operator”.

As shown in FIG. 6, a subprogram development object may perform a trigger operation on the media reference controlling control 61c. In this way, the terminal device may, in response to the trigger operation performed by the subprogram development object on the media reference controlling control 61c, switch the subprogram management page 60a to the subprogram management page 60b, and display the media reference description information 62a and a media reference controlling control 62b in the subprogram management page 60b. A control state of the media reference controlling control 62b is an on state (that is, the media reference controlling control 61c in the off state is updated to the media reference controlling control 62b in the open state). For example, the media reference description information 62a may be “acquisition permission will be automatically closed in TTT, and any video identifier input parameter cannot be copied” and “acquisition permission will be automatically closed in TTT, and any video account video identifier input parameter cannot be copied on a mobile terminal”. The TTT may represent a moment at which a default time period is reached. For example, when a moment at which the subprogram development object performs a trigger operation on the media reference controlling control 61c is Feb. 1, 2023, 11:12, the TTT may be Feb. 2, 2023, 11:12.

The media interaction platform is further configured for providing an interaction management page to a publishing object configured for publishing media data. The interaction management page includes subprogram reference description information and a subprogram reference controlling control corresponding to the subprogram reference description information. A control state of the subprogram reference controlling control is an off state. The subprogram reference controlling control is configured for instructing to update and display the subprogram reference controlling control from the off state to an on state (i.e., updating the subprogram reference controlling control in the off state to a subprogram reference controlling control in the on state) when the publishing object performs a trigger operation on the subprogram reference controlling control. The subprogram reference controlling control in the on state is configured for indicating that the media data published by the publishing object satisfies the media reference condition.

When the publishing object and the subprogram development object are the same object, the publishing object and the subprogram development object may log in to the media interaction platform through the same account. In some embodiments, when the publishing object and the subprogram development object are different objects, the publishing object and the subprogram development object may log in to the media interaction platform through different accounts. A media interaction platform to which the publishing object logs in and a media interaction platform to which the subprogram development object logs in may be collectively referred to as a media interaction platform.

Similarly, the media interaction platform is further configured for providing an interaction management page to a publishing object configured for publishing media data. The interaction management page includes subprogram reference description information and a subprogram reference controlling control corresponding to the subprogram reference description information. The control state of the subprogram reference controlling control is the on state. The subprogram reference controlling control is configured for instructing to update and display the subprogram reference controlling control from the on state to the off state (i.e., updating the subprogram reference controlling control in the on state to the subprogram reference controlling control in the off state) when the publishing object performs a trigger operation on the subprogram reference controlling control.

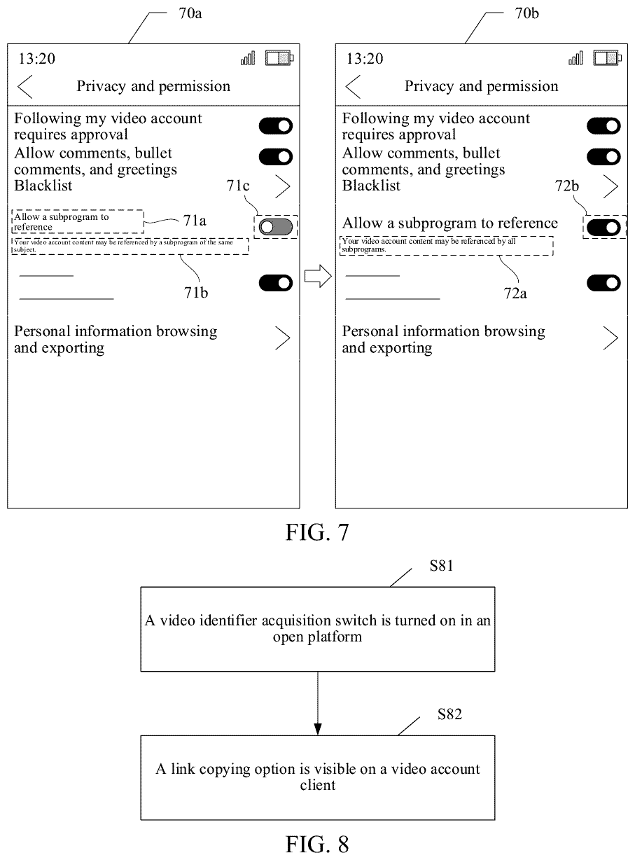

For ease of understanding, FIG. 7 is a schematic diagram of a scene for triggering a subprogram reference controlling control according to an embodiment of this disclosure. An interaction management page 70a and an interaction management page 70b shown in FIG. 7 may be pages of a media interaction platform at different moments. The interaction management page 70a may include subprogram reference description information and a subprogram reference controlling control 71c, and a control state of the subprogram reference controlling control 71c is an off state. The subprogram reference description information may include subprogram reference description information 71a and subprogram reference description information 71b. The subprogram reference description information 71a may be a description title, and the subprogram reference description information 71b may be description content. For example, the subprogram reference description information 71b may be “your video account content may be referenced by a subprogram of the same subject”.

As shown in FIG. 7, a publishing object may perform a trigger operation on the subprogram reference controlling control 71c. In this way, a terminal device corresponding to the publishing object may, in response to the trigger operation performed by the publishing object on the subprogram reference controlling control 71c, switch the interaction management page 70a to the interaction management page 70b, and display subprogram reference description information 72a and a subprogram reference controlling control 72b on the interaction management page 70b. A control state of the subprogram reference controlling control 72b is an on state (that is, the subprogram reference controlling control 71c in the off state is updated to the subprogram reference controlling control 72b in the on state). For example, the subprogram reference description information 72a may be “your video account content may be referenced by all subprograms”.

In some embodiments, the terminal device corresponding to the publishing object may further display, in the interaction management page 70b, a subprogram reference list associated with the publishing object. A subprogram in the subprogram reference list may be a subprogram referencing the media data published by the publishing object. In some embodiments, the interaction management page 70b may further be configured to display subprogram controls corresponding to the subprograms in the subprogram reference list. The subprogram control may be configured to control whether the subprogram in the subprogram reference list may continue to reference the referenced media data. For example, the subprogram reference list may include a target subprogram referencing the media data and a subprogram control corresponding to the target subprogram referencing the media data. When a control state of the subprogram control corresponding to the target subprogram referencing the media data is an off state, the media data in the target subprogram referencing the media data cannot be normally displayed. When the control state of the subprogram control corresponding to the target subprogram referencing the media data is an on state, the media data in the target subprogram referencing the media data may be normally displayed.

An operation procedure of the subprogram development object to reference media data may refer to FIG. 8. FIG. 8 is a schematic flowchart of referencing media data according to an embodiment of this disclosure. Operation S81 to operation S82 shown in FIG. 8 are described using an example in which a media interaction platform is a video interaction platform, media data is video data, and a media server is a video server.

As shown in FIG. 8, the terminal device may perform operation S81. A video identifier acquisition switch is turned on (that is, a control state of a media reference controlling control is set to an on state) in an open platform (i.e., a subprogram open platform) through operation S81. The subprogram open platform is a module in a media platform (MP), and the MP may alternatively be referred to as a subprogram platform. Further, the terminal device may perform operation S82. A link copying option (i.e., a media reference control) is visible on a video account client (i.e., a video interaction platform) through operation S82, and then an external credential for the media data is acquired based on the media reference control.

Subprogram development objects of the target subprogram may set a control state of a media reference controlling control to the on state through the subprogram platform. In this way, a subprogram development object that turns on the media reference controlling control may see the media reference control in the media interaction platform, and a subprogram development object that does not turn on the media reference controlling control cannot see the media reference control in the media interaction platform. For example, the subprogram development objects of the target subprogram may include a subprogram development object Y₁ and a subprogram development object Y₂. When the subprogram development object Y₁ sets the control state of the media reference controlling control to the on state, and the subprogram development object Y₂ does not set the control state of the media reference controlling control to the on state, the subprogram development object Y₁ may see the media reference control in the media interaction platform logged in through its own account, and the subprogram development object Y₂ cannot see the media reference control in the media interaction platform logged in through its own account.

It can be seen that in this embodiment of this disclosure, the media reference control and the subprogram selection list may be sequentially displayed in the media interaction platform when the media data and the subprogram development object simultaneously satisfy the media reference condition, and then the external credential for the media data and the target subprogram is acquired based on the subprogram selection list, thereby improving the efficiency of acquiring the external credential when the external credential is acquired through the media reference control and the subprogram list. In this case, regardless of whether the subprogram development object and the publishing object publishing the media data are the same subject object, as long as the media data and the subprogram development object simultaneously satisfy the media reference condition, the subprogram development object may acquire, based on the media reference control, the external credential configured for referencing the media data to the target subprogram, so as to display the media data in the target subprogram referencing the media data (that is, the media data may be referenced to the subprogram of the subprogram development object without limitation to a subject), thereby presenting the media data in the target subprogram, and improving the capability of circulating, in the subprogram, the media data in the media interaction platform. In addition, the security of referencing the media data may be improved by determining whether the media data and the subprogram development object simultaneously satisfy the media reference condition.

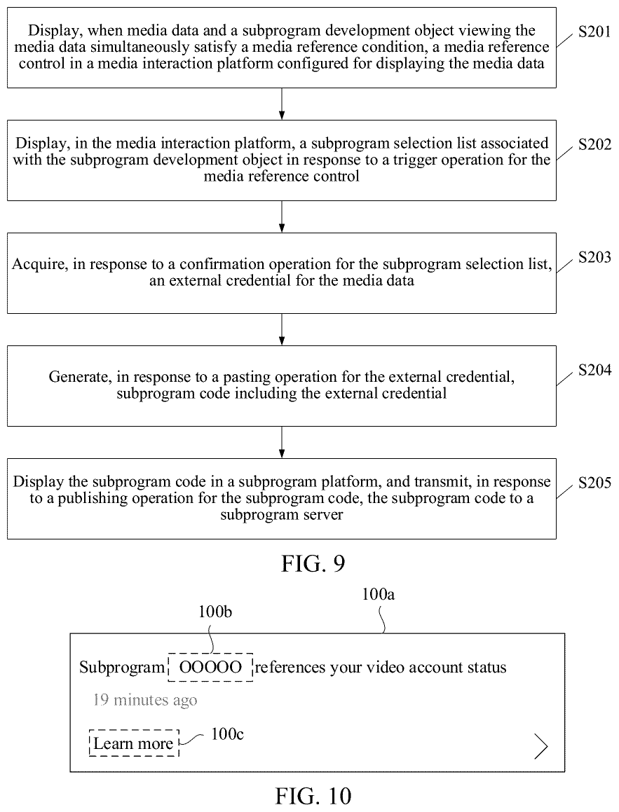

Further, FIG. 9 is a schematic flowchart of a data processing method according to an embodiment of this disclosure. The method may be performed by a media server, by a terminal device, or by the media server and the terminal device. The media server may be the media server 20a in the foregoing embodiment corresponding to FIG. 2, and the terminal device may be the terminal device 20b in the foregoing embodiment corresponding to FIG. 2. For ease of understanding, this embodiment of this disclosure is described using an example in which the method is performed by the terminal device. The data processing method may include the following operation S201 to operation S205.

Operation S201: Display, when media data and a subprogram development object viewing the media data simultaneously satisfy a media reference condition, a media reference control in a media interaction platform configured for displaying the media data.

Specifically, the terminal device may display the media data in the media interaction platform. The media interaction platform includes a media forwarding control. Further, the terminal device may generate, in response to a trigger operation for the media forwarding control, a media forwarding request based on a development object identifier of the subprogram development object and a media identifier of the media data, and transmit the media forwarding request to a media server. The media forwarding request is configured for instructing the media server to perform condition analysis on the development object identifier and the media identifier to obtain a condition analysis result. The media server is configured to return a temporary bill to the media interaction platform when the condition analysis result indicates that the media data and the subprogram development object simultaneously satisfy the media reference condition. The temporary bill is obtained by the media server encrypting the development object identifier and the media identifier. Further, the terminal device may receive the temporary bill returned by the media server and display a media reference control in the media interaction platform based on the temporary bill.

A specific process in which the media server performs condition analysis on the development object identifier and the media identifier may refer to the description of operation S401 in the following embodiment corresponding to FIG. 13.

In some embodiments, the media server is further configured to not need to return the temporary bill to the media interaction platform when the condition analysis result indicates that the media data and the subprogram development object do not satisfy the media reference condition. Therefore, the terminal device does not need to display the media reference control in the media interaction platform.

Operation S202: Display, in the media interaction platform, a subprogram selection list associated with the subprogram development object in response to a trigger operation for the media reference control.

A specific process in which the terminal device displays the subprogram selection list in the media interaction platform may refer to the description of operation S102 in the foregoing embodiment corresponding to FIG. 3, and details are not described herein again.

Operation S203: Acquire, in response to a confirmation operation for the subprogram selection list, an external credential for the media data.

Specifically, a selection confirmation control for the target subprogram is displayed in the media interaction platform when there is one subprogram associated with the subprogram development object. The target subprogram is a subprogram selected by the subprogram development object from the subprogram selection list. Further, the terminal device may generate, in response to a trigger operation for the selection confirmation control, a security check request based on the development object identifier of the subprogram development object, a subprogram identifier of the target subprogram, and the temporary bill, and transmit the security check request to the media server. The security check request is configured for instructing the media server to perform a security check on the development object identifier and the temporary bill to obtain a security check result. The media server is configured to return the external credential for the media data to the media interaction platform when the security check result indicates that the security check succeeds. The external credential is obtained by the media server encrypting the subprogram identifier and the temporary bill, and the temporary bill is obtained by the media server encrypting the development object identifier and the media identifier of the media data. Further, the terminal device may receive the external credential returned by the media server. The external credential is configured for instructing the subprogram development object to reference the media data to the target subprogram, and the target subprogram referencing the media data has permission to display the media data.

A specific process in which the media server performs the security check on the development object identifier and the temporary bill may refer to the description of operation S403 in the following embodiment corresponding to FIG. 13.

Similarly, a specific process in which the terminal device responds to the trigger operation for the selection confirmation control when there are a plurality of subprograms associated with the subprogram development object may refer to the foregoing description of responding to the trigger operation of the selection confirmation control when there is one subprogram associated with the subprogram development object, and details are not described herein again.

In some embodiments, the media server is further configured to return a media reference failure notification to the media interaction platform when the security check result indicates that the security check fails. Therefore, the terminal device may receive the media reference failure notification returned by the media server and display the media reference failure notification in the media interaction platform. For example, the media reference failure notification may be “this video account status cannot be referenced”.

In some embodiments, the media server may generate, when the number of credentials is greater than or equal to a quantity threshold, the security check result configured for indicating that the security check fails. That is, the security check fails because the number of credentials is greater than or equal to the quantity threshold. In this case, the media reference failure notification displayed in the media interaction platform by the terminal device may be “the number of copies reaches an upper limit, please try again later”.

Operation S204: Generate, in response to a pasting operation for the copied external credential, subprogram code including the external credential.

The subprogram development object may edit the subprogram code through a subprogram development tool, and paste, in the subprogram development tool, the external credential to the subprogram code using a video account component (for example, a channel- video component) provided by the subprogram platform (for example, the external credential is pasted to a token field of the video account component) to generate the subprogram code including the external credential.

Operation S205: Display the subprogram code in the subprogram platform, and transmit, in response to a publishing operation for the subprogram code, the subprogram code to a subprogram server.

The subprogram server is configured to perform program compiling on the subprogram code to obtain the target subprogram referencing the media data. The target subprogram referencing the media data is configured for instructing the subprogram server to push a media reference notification to a publishing object configured for publishing the media data.

The subprogram server is configured to compare the media data with the media reference condition in the process of performing program compiling on the subprogram code, to obtain a condition comparison result. The subprogram server is further configured to determine, when the condition comparison result indicates that the media data satisfies the media reference condition, that the compiling succeeds, to obtain the target subprogram referencing the media data. When a control state of the subprogram reference controlling control is an on state, the media data satisfies the media reference condition. When the control state of the subprogram reference controlling control is an off state, and the subprogram development object and the publishing object are the same subject object, the media data satisfies the media reference condition.

In some embodiments, the subprogram server is further configured to determine, when the condition comparison result indicates that the media data does not satisfy the media reference condition, that the compiling fails, and return a program compiling failure notification to the subprogram platform. In this case, the subprogram code is unsuccessfully published. When the control state of the subprogram reference controlling control is the off state, and the subprogram development object and the publishing object are different subject objects, the media data does not satisfy the media reference condition. Therefore, the terminal device may receive the program compiling failure notification returned by the subprogram server and display the program compiling failure notification in the subprogram platform. For example, the program compiling failure notification may be “due to the author's privacy setting, this video account content can only be referenced by a subprogram operated by the author”.

For ease of understanding, FIG. 10 is a schematic diagram of a scene for pushing a media reference notification according to an embodiment of this disclosure. As shown in FIG. 10, a terminal device corresponding to a publishing object may receive a media reference notification 100a pushed by a subprogram server, and display, in a media interaction platform, the media reference notification 100a pushed by the subprogram server. In some embodiments, the terminal device corresponding to the publishing object may alternatively display the media reference notification 100a in a host application integrated by the media interaction platform so that the publishing object may acquire a reference situation for the published media data in time.

The media reference notification 100a may include a subprogram name 100b (for example, the subprogram name 100b may be “00000”) of a target subprogram referencing the media data and a reference viewing control 100c (i.e., learn more in FIG. 10). The publishing object may perform a trigger operation on the reference viewing control 100c. In this way, the terminal device corresponding to the publishing object may, in response to the trigger operation performed by the terminal device on the reference viewing control 100c, open a media data reference page (i.e., a subpage of the media data in the target subprogram referencing the media data) corresponding to the target subprogram referencing the media data or a home page of the target subprogram referencing the media data. The media data reference page corresponding to the target subprogram referencing the media data and the home page of the target subprogram referencing the media data may be the same or different. In some embodiments, the media reference notification 100a may further include a page name and reference time of a page of the media data in the target subprogram referencing the media data.

It can be seen that in this embodiment of this disclosure, the external credential for the media data may be acquired when the media data and the subprogram development object simultaneously satisfy the media reference condition, then the subprogram code including the external credential is generated, and the target subprogram referencing the media data is generated according to the subprogram code. The target subprogram referencing the media data may be configured for displaying the media data, thereby improving the capability of circulating, in the subprogram, the media data in the media interaction platform.

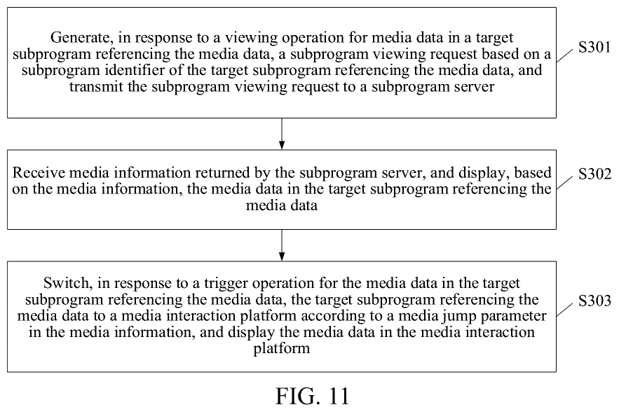

Further, FIG. 11 is a schematic flowchart of a data processing method according to an embodiment of this disclosure. The method may be performed by a media server, by a terminal device, or by the media server and the terminal device. The media server may be the media server 20a in the foregoing embodiment corresponding to FIG. 2, and the terminal device may be the terminal device 20b in the foregoing embodiment corresponding to FIG. 2. For ease of understanding, this embodiment of this disclosure is described using an example in which the method is performed by the terminal device. The data processing method may include the following operation S301 to operation S303.

Operation S301: Generate, in response to a viewing operation for the media data in the target subprogram referencing the media data, a subprogram viewing request based on a subprogram identifier of the target subprogram referencing the media data, and transmit the subprogram viewing request to the subprogram server.

The subprogram viewing request is configured for instructing the subprogram server to transmit the subprogram identifier and the external credential to the media server after acquiring the external credential for the media data. The media server is configured to perform a credential check on the subprogram identifier and the external credential to obtain a credential check result. The media server is further configured to return media information corresponding to the media data to the subprogram server when the credential check result indicates that the credential check succeeds. The subprogram server is configured to return the media information to the target subprogram referencing the media data. The media information includes, but is not limited to, a media cover image of the media data (for example, a video cover image of video data), an object name of a publishing object, and a media jump parameter.

When an interaction object (for example, a subprogram development object) opens the target subprogram referencing the media data through the terminal device, the terminal device may respond to a viewing operation for the media data in the target subprogram referencing the media data. In some embodiments, when the media data is in a subpage of the target subprogram referencing the media data, the terminal device may respond to the viewing operation on the media data in the target subprogram referencing the media data when the interaction object (for example, the subprogram development object) opens the subpage of the target subprogram through the terminal device.

A specific process in which the media server performs the credential check on the subprogram identifier and the external credential may refer to the description of operation S502 in the following embodiment corresponding to FIG. 15.

In some embodiments, the media server is further configured to return a media viewing failure notification to the subprogram server when the credential check result indicates that the credential check fails. The subprogram server is configured to return the media viewing failure notification to the target subprogram referencing the media data. Therefore, the terminal device may receive the media viewing failure notification returned by the subprogram server and display the media viewing failure notification in the target subprogram referencing the media data. The credential check failure may indicate that after the target subprogram referencing the media data is normally published, the publishing object sets the control state of the subprogram reference controlling control to an off state through the media interaction platform (it is assumed herein that the subprogram development object and the publishing object are different subject objects). For example, the media viewing failure notification may be “this video account status cannot be presented”. The terminal device may display the media viewing failure notification in an area referencing the media data, and other areas except the area referencing the media data are normally displayed.

Operation S302: Receive the media information returned by the subprogram server, and display, based on the media information, the media data in the target subprogram referencing the media data.

Specifically, when the subprogram development object and the publishing object are different subject objects (that is, a subject object corresponding to the target subprogram developed by the subprogram development object is different from a subject object corresponding to the account created by the publishing object), the terminal device may display the media cover image in the target subprogram referencing the media data. In some embodiments, when the subprogram development object and the publishing object are the same subject object (that is, the subject object corresponding to the target subprogram developed by the subprogram development object is the same as the subject object corresponding to the account created by the publishing object), the terminal device may receive media content corresponding to the media data transmitted by the subprogram server and display the media content in the target subprogram referencing the media data. For example, when the media data is video data, the media content may be a video frame of the video data, and the media cover image may be a video cover image of the video data. For another example, when the media data is graphic and textual data, the media content may be text content of the graphic and textual data, and the media cover image may be a cover image of the graphic and textual data. In other words, when the media data is video data, the terminal device may automatically play the video data when the subprogram development object and the publishing object are the same subject object (i.e., the same subject). When the subprogram development object and the publishing object are different subject objects (i.e., not the same subject), the terminal device may not allow the video data to be automatically played.

While displaying the media cover image in the target subprogram referencing the media data, the terminal device may display a media viewing control (for example, a video playing control) in the target subprogram referencing the media data. In this way, the subprogram development object may perform a trigger operation on the media viewing control. Thus, the terminal device may receive, in response to the trigger operation performed by the subprogram development object on the media viewing control, the media content corresponding to the media data transmitted by the subprogram server, and display the media content in the target subprogram referencing the media data. That is, the media cover image is switched to the media content (for example, the video cover image is switched to the video frame in the video data, that is, the video data starts to be played).

While displaying the media cover image in the target subprogram referencing the media data, the terminal device may further display the object name of the publishing object. For example, the object name of the publishing object may be displayed on the media cover image. In some embodiments, while displaying the media content in the target subprogram referencing the media data, the terminal device may further display the object name of the publishing object. For example, the object name of the publishing object may be displayed on the media content.

When creating an account in the media interaction platform, the publishing object (i.e., an administrator) needs to select a subject type (that is, subject authentication needs to be performed) corresponding to the created account, and then determines a subject object under the subject type. When creating a subprogram in the subprogram platform, the subprogram development object (for example, an administrator) needs to select a subject type (that is, subject authentication needs to be performed) corresponding to the created subprogram (for example, the target subprogram), and then determines a subject object in the subject type. The subject object may alternatively be referred to as an authentication subject, and the subject type may include, but is not limited to, an enterprise, a person, and media. For example, a range of the person may be a real-name user over 18 years old, a range of the enterprise may be an enterprise, a branch organization, and a brand related to the enterprise, and a range of the media may include, but is not limited to, a newspaper, a magazine, a television, a radio station, and a news agency. For example, a subject object under the enterprise may be a cosmetics enterprise, and a subject object under the media may be a periodical office.

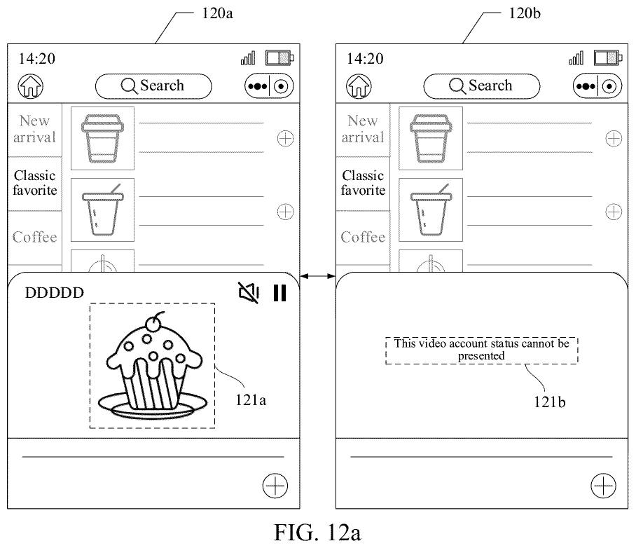

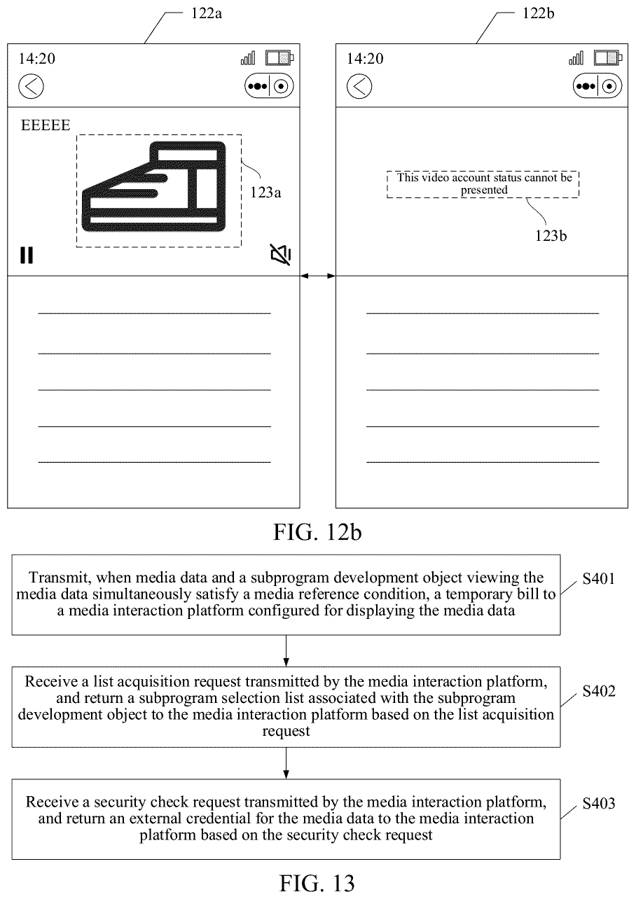

For ease of understanding, FIG. 12a and FIG. 12b each are a schematic diagram of a scene for viewing a target subprogram according to an embodiment of this disclosure. As shown in FIG. 12a, a subprogram interface 120a may be an interface displayed by a target subprogram referencing media data when a media server determines that a credential check succeeds. In some embodiments, a subprogram interface 120b may be an interface displayed by the target subprogram referencing the media data when the media server determines that the credential check fails.

As shown in FIG. 12a, a terminal device may receive media information returned by a subprogram server, display media data (for example, a media cover image 121a) in the subprogram interface 120a based on the media information, and display an object name (for example, “DDDDD”) on the media cover image 121a. In some embodiments, the terminal device may receive a media viewing failure notification 121b returned by the subprogram server and display the media viewing failure notification 121b in the subprogram interface 120b.

As shown in FIG. 12b, a subprogram interface 122a may be an interface displayed by a target subprogram referencing media data when a media server determines that a credential check succeeds. In some embodiments, a subprogram interface 122b may be an interface displayed by the target subprogram referencing the media data when the media server determines that the credential check fails.

As shown in FIG. 12b, a terminal device may receive media information returned by a subprogram server, display media data (for example, a media cover image 123a) in the subprogram interface 122a based on the media information, and display an object name (for example, “EEEEE”) on the media cover image 123a. In some embodiments, the terminal device may receive a media viewing failure notification 123b returned by the subprogram server and display the media viewing failure notification 123b in the subprogram interface 122b.

Operation S303: Switch, in response to a trigger operation for the media data in the target subprogram referencing the media data, the target subprogram referencing the media data to the media interaction platform according to a media jump parameter (i.e., a jump link) in the media information, and display the media data in the media interaction platform.

When the media data is displayed in the media interaction platform, the terminal device may display interaction information for the media data through the media interaction platform, but cannot display the interaction information for the media data through the target subprogram referencing the media data. In this way, the user privacy leakage caused by the acquisition of the interaction information by a subprogram developer not of the same subject may be avoided, thereby improving the security of referencing the media data. The subprogram developer not of the same subject herein refers to a subprogram developer whose subject is different from that of the publishing object of the media data. The interaction information may include, but is not limited to, the number of likes, comment information, and bullet comment information. Therefore, when the subprogram development object needs to view the interaction information for the media data, a trigger operation may be performed on the media data (for example, the media cover image) in the target subprogram referencing the media data.

It can be seen that in this embodiment of this disclosure, when responding to a viewing operation for the media data in the target subprogram referencing the media data, media information corresponding to the media data may be acquired, and the media data is displayed in the target subprogram referencing the media data based on the media information, thereby improving the capability of circulating, in the subprogram, the media data in the media interaction platform. In addition, in this embodiment of this disclosure, when responding to the trigger operation for the media data in the target subprogram referencing the media data, the target subprogram referencing the media data is switched to the media interaction platform, thereby improving an association relationship between the media interaction platform and the target subprogram referencing the media data.

Further, FIG. 13 is a schematic flowchart of a data processing method according to an embodiment of this disclosure. The method may be performed by a media server, by a terminal device, or by the media server and the terminal device. The media server may be the media server 20a in the foregoing embodiment corresponding to FIG. 2, and the terminal device may be the terminal device 20b in the foregoing embodiment corresponding to FIG. 2. For ease of understanding, this embodiment of this disclosure is described using an example in which the method is performed by the media server. The data processing method may include the following operation S401 to operation S403.

Operation S401: Transmit, when media data and a subprogram development object viewing the media data simultaneously satisfy a media reference condition, a temporary bill to a media interaction platform configured for displaying the media data.

Specifically, the media server may receive a media forwarding request transmitted by the media interaction platform configured for displaying the media data, and acquire, from the media forwarding request, a development object identifier of the subprogram development object viewing the media data and a media identifier of the media data. The media interaction platform is different from a subprogram platform configured for maintaining a subprogram. Further, the media server may perform condition analysis on the development object identifier and the media identifier to obtain a condition analysis result. Further, the media server may encrypt, when the condition analysis result indicates that the media data and the subprogram development object simultaneously satisfy the media reference condition, the development object identifier and the media identifier to obtain the temporary bill. A specific encryption algorithm used in the encryption processing is not limited in this embodiment of this disclosure. Further, the media server may transmit the temporary bill to the media interaction platform. The temporary bill is configured for instructing the media interaction platform to display a media reference control.

A specific process in which the media server performs condition analysis on the development object identifier and the media identifier may be described as follows. The media server may acquire a control state of a media reference controlling control associated with the development object identifier and acquire a control state of a subprogram reference controlling control associated with the media identifier. The media reference controlling control is a control displayed in the subprogram platform when the subprogram development object logs in to the subprogram platform. The subprogram reference controlling control is a control displayed in an interaction management page of the media interaction platform when a publishing object publishing the media data logs in to the media interaction platform. Further, the media server may perform media review on the media data corresponding to the media identifier to generate a media review result corresponding to the media data. Further, the media server may generate, when the control state of the media reference controlling control is an on state, the control state of the subprogram reference controlling control is an on state, and the media review result indicates that the media review succeeds, the condition analysis result configured for indicating that the media data and the subprogram development object simultaneously satisfy the media reference condition. In other words, the media server may generate, when the control state of the media reference controlling control is the on state, the condition analysis result configured for indicating that the subprogram development object satisfies the media reference condition. The media server may generate, when the control state of the subprogram reference controlling control is the on state, and the media review result indicates that the media review succeeds, the condition analysis result configured for indicating that the media data satisfies the media reference condition.

The media review may be configured for determining whether the media data is suitable for being propagated (for example, whether the media data is a sensitive topic). When the media data is suitable for being propagated, a media review result configured for indicating that the media review succeeds is generated. In some embodiments, when the media data is not suitable for being propagated, a media review result configured for indicating that the media review fails is generated.

In some embodiments, the media server may generate, when the control state of the subprogram reference controlling control is the off state, the subprogram development object and the publishing object are the same subject object, the control state of the media reference controlling control is the on state, and the media review result indicates that the media review succeeds, a condition analysis result configured for indicating that the media data and the subprogram development object do not satisfy the media reference condition. In other words, the media server may generate, when the control state of the media reference controlling control is the on state, the condition analysis result configured for indicating that the subprogram development object satisfies the media reference condition. The media server may generate, when the control state of the subprogram reference controlling control is the off state, the subprogram development object and the publishing object are the same subject object, and the media review result indicates that the media review succeeds, the condition analysis result configured for indicating that the media data satisfies the media reference condition.

In some embodiments, the media server may generate, when the control state of the media reference controlling control is the on state, and the control state of the subprogram reference controlling control is the on state, the condition analysis result configured for indicating that the media data and the subprogram development object simultaneously satisfy the media reference condition. In other words, the media server may generate, when the control state of the media reference controlling control is the on state, the condition analysis result configured for indicating that the subprogram development object satisfies the media reference condition. The media server may generate, when the control state of the subprogram reference controlling control is the on state, the condition analysis result configured for indicating that the media data satisfies the media reference condition.

In some embodiments, the media server may generate, when the control state of the subprogram reference controlling control is the off state, the subprogram development object and the publishing object are the same subject object, and the control state of the media reference controlling control is the on state, the condition analysis result configured for indicating that the media data and the subprogram development object do not satisfy the media reference condition. In other words, the media server may generate, when the control state of the media reference controlling control is the on state, the condition analysis result configured for indicating that the subprogram development object satisfies the media reference condition. The media server may generate, when the control state of the subprogram reference controlling control is the off state, and the subprogram development object and the publishing object are the same subject object, the condition analysis result configured for indicating that the media data satisfies the media reference condition.

In some embodiments, the media server may generate, when the control state of the media reference controlling control is the off state, or the media review result indicates that the media review fails, the condition analysis result configured for indicating that the media data and the subprogram development object do not satisfy the media reference condition. In other words, the media server may generate, when the control state of the media reference controlling control is the off state, the condition analysis result configured for indicating that the subprogram development object does not satisfy the media reference condition. The media server may generate, when the media review result indicates that the media review fails, the condition analysis result configured for indicating that the media data does not satisfy the media reference condition.

In some embodiments, the media server may generate, when the control state of the subprogram reference controlling control is the off state, and the subprogram development object and the publishing object are different subject objects, the condition analysis result configured for indicating that the media data and the subprogram development object do not satisfy the media reference condition. In other words, the media server may generate, when the control state of the subprogram reference controlling control is the off state, and the subprogram development object and the publishing object are different subject objects, the condition analysis result configured for indicating that the media data does not satisfy the media reference condition.

Therefore, without considering the media review result, when the subprogram development object and the publishing object are the same subject object, regardless of whether the control state of the subprogram reference controlling control is the off state or the on state, the media server may generate the condition analysis result configured for indicating that the media data satisfies the media reference condition. Without considering the media review result, when the subprogram development object and the publishing object are different subject objects, if the control state of the subprogram reference controlling control is the off state, the media server may generate the condition analysis result configured for indicating that the media data does not satisfy the media reference condition, and if the control state of the subprogram reference controlling control is the on state, the media server may generate the condition analysis result configured for indicating that the media data satisfies the media reference condition.

Operation S402: Receive a list acquisition request transmitted by the media interaction platform, and return a subprogram selection list associated with the subprogram development object to the media interaction platform based on the list acquisition request.

Specifically, the media server may receive a list acquisition request transmitted by a video interaction platform, and acquire, based on the list acquisition request, the subprogram selection list associated with the subprogram development object from the subprogram server. Further, the media server may return the subprogram selection list to the video interaction platform. The list acquisition request is transmitted by the media interaction platform when responding to a trigger operation for the media reference control. The video interaction platform is configured for displaying the subprogram selection list.

The subprogram selection list may include a subprogram associated with the subprogram development object, and the subprogram associated with the subprogram development object may represent a subprogram developed by the subprogram development object, that is, the subprogram development object may be used as an administrator or a developer of the subprogram associated with the subprogram development object. The number of subprograms associated with the subprogram development object is not limited in this embodiment of this disclosure.

Operation S403: Receive a security check request transmitted by the media interaction platform, and return an external credential for the media data to the media interaction platform based on the security check request.

Specifically, the media server may receive the security check request transmitted by the media interaction platform and acquire a development object identifier of the subprogram development object, a subprogram identifier of the target subprogram, and the temporary bill from the security check request. Further, the media server may perform a security check on the development object identifier and the temporary bill to obtain a security check result. Further, the media server may encrypt, when the security check result indicates that the security check succeeds, the subprogram identifier and the temporary bill to obtain the external credential for the media data. A specific encryption algorithm used in the encryption processing is not limited in this embodiment of this disclosure. Further, the media server may return the external credential to the media interaction platform. The security check request is transmitted by the media interaction platform when responding to a confirmation operation for a target subprogram in the subprogram selection list. The external credential is configured for instructing the subprogram development object to reference the media data to the target subprogram, and the target subprogram referencing the media data has permission to display the media data.

A specific process in which the media server performs the security check on the development object identifier and the temporary bill may be described as follows. The media server may perform decrypt the temporary bill to obtain a to-be-verified object identifier in the temporary bill and a media identifier of the media data, The temporary bill is obtained by encrypting the to-be-verified object identifier and the media identifier of the media data. Further, the media server may acquire the number of external credentials acquired by the subprogram development object corresponding to the development object identifier in a target time period. Further, the media server may acquire the control state of the subprogram reference controlling control associated with the media identifier. The subprogram reference controlling control is a control displayed in an interaction management page of the media interaction platform when the publishing object publishing the media data logs in to the media interaction platform. Further, the media server may generate, when the development object identifier is the same as the to-be-verified object identifier, the number of credentials is less than a quantity threshold, and the control state of the subprogram reference controlling control is the on state, the security check result configured for indicating that the security check succeeds.

The quantity threshold may be configured for controlling the maximum number of external credentials that may be acquired by the subprogram development object in the target time period, to avoid the abuse of the function of acquiring the external credentials by the subprogram development object in the media interaction platform. A specific period duration of the target time period is not limited in this embodiment of this disclosure. For example, the target time period may be 24 hours or 10 minutes. A specific value of the quantity threshold is not limited in this embodiment of this disclosure. For example, the quantity threshold may be 5 or 10. Further, when the security check result indicates that the security check succeeds, the media server may accumulate the number of certificates to obtain an accumulated number of certificates (that is, a sum of a default parameter (i.e., 1) and the number of certificates is determined as the accumulated number of certificates).

In some embodiments, the media server may generate, when the development object identifier is the same as the to-be-verified object identifier, the number of credentials is less than the quantity threshold, the control state of the subprogram reference controlling control is the off state, and the subprogram development object and the publishing object are the same subject object, the security check result configured for indicating that the security check succeeds.

In some embodiments, the media server may generate, when the development object identifier and the to-be-verified object identifier are different, or the number of credentials is not less than the quantity threshold (that is, the number of credentials is greater than or equal to the quantity threshold), a security check result configured for indicating that the security check fails. When the development object identifier and the to-be-verified object identifier are different, the media server may determine that the temporary bill in the security check request is not generated for the development object identifier. In some embodiments, the media server may generate, when the control state of the subprogram reference controlling control is the off state, and the subprogram development object and the publishing object are different subject objects, the security check result configured for indicating that the security check fails.

In some embodiments, the media server may generate, when the development object identifier is the same as the to-be-verified object identifier, the security check result configured for indicating that the security check succeeds. In some embodiments, the media server may generate, when the development object identifier and the to-be-verified object identifier are different, the security check result configured for indicating that the security check fails.

Due to the characteristic of low creation cost of a subprogram developed by a personal subject, to avoid the abuse of the media data in the media interaction platform by the subprogram of the personal subject, this embodiment of this disclosure may be applicable to a developer of a subprogram of a non-personal body to reference the media data. Therefore, when generating the security check result configured for indicating that the security check succeeds, the terminal device may ensure that the subject type corresponding to the target subprogram is the non-personal subject. When the subject type corresponding to the target subprogram is the personal subject, the terminal device generates the security check result configured for indicating that the security check fails.

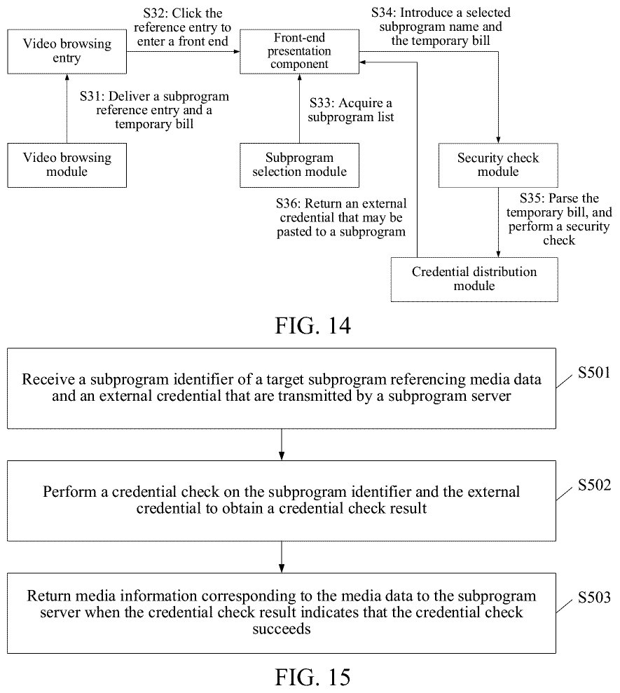

For ease of understanding, FIG. 14 is a schematic flowchart of copying an external credential according to an embodiment of this disclosure. As shown in FIG. 14, a specific process of copying the external credential may include operation S31 to operation S36. Operation S31 to operation S36 are described using an example in which a media interaction platform is a video interaction platform, media data is video data, and a media server is a video server. The video interaction platform may include a video browsing entry and a front-end presentation component. The video server may include a video browsing module (i.e., a video account browsing module), a subprogram selection module, a security check module, and a credential distribution module.

As shown in FIG. 14, when a subprogram development object views the video data through the video browsing entry, a trigger operation may be performed on a media forwarding control in the video interaction platform. In this way, a terminal device may transmit, in response to the trigger operation performed by the subprogram development object on the media forwarding control, the media forwarding request to the video server. Further, the video server may determine, through the video browsing module, whether the media data and the subprogram development object simultaneously satisfy a media reference condition, and then deliver, when the media data and the subprogram development object simultaneously satisfy the media reference condition, a subprogram reference entry (i.e., a media reference control) of the video data and a temporary bill to the video browsing entry through operation S31.

As shown in FIG. 14, the subprogram development object may click the reference entry to enter the front end (that is, a trigger operation is performed on the media reference control to enter the front-end presentation component) through operation S32. In this way, the terminal device may transmit, in response to the trigger operation performed by the subprogram development object on the media reference control, the media forwarding request to the video server through the front-end presentation component. Further, the video server may acquire a subprogram list (i.e., a subprogram selection list) associated with the subprogram development object through the subprogram selection module and return the subprogram list to the front-end presentation component through operation S33.

As shown in FIG. 14, the subprogram development object may perform a confirmation operation on the subprogram list (that is, a determined target subprogram is selected from the subprogram list). In this way, the terminal device may transmit, in response to the confirmation operation performed by the subprogram development object on the subprogram list, a security check request to the media server through operation S34. The security check request may include a selected subprogram name (i.e., a subprogram identifier of the target subprogram), a temporary bill, and a development object identifier of the subprogram development object. Further, the video server may perform operation S35 through the security check module, parses the temporary bill and performs a security check through operation S35, and further transmits a security check result to the credential distribution module. In this way, when the security check result indicates that the security check succeeds, the credential distribution module may convert the temporary bill into a secure and harmless external credential, and return the external credential that may be pasted to a subprogram to the front-end presentation component through operation S36.

It can be seen that in this embodiment of this disclosure, the temporary bill for the media data may be acquired when the media data and the subprogram development object simultaneously satisfy the media reference condition, and then the external credential for the media data is acquired. In this case, in this embodiment of this disclosure, regardless of whether the subprogram development object and the publishing object publishing the media data are the same subject object, as long as the media data and the subprogram development object simultaneously satisfy the media reference condition, the external credential configured for referencing the media data to the target subprogram may be acquired, so as to display the media data in the target subprogram referencing the media data (that is, the media data may be referenced to the subprogram of the subprogram development object without limitation to a subject), thereby improving the capability of circulating, in the subprogram, the media data in the media interaction platform. In addition, the security of referencing the media data may be improved by determining whether the media data and the subprogram development object simultaneously satisfy the media reference condition.

Further, FIG. 15 is a schematic flowchart of a data processing method according to an embodiment of this disclosure. The method may be performed by a media server, by a terminal device, or by the media server and the terminal device. The media server may be the media server 20a in the foregoing embodiment corresponding to FIG. 2, and the terminal device may be the terminal device 20b in the foregoing embodiment corresponding to FIG. 2. For ease of understanding, this embodiment of this disclosure is described using an example in which the method is performed by the media server. The data processing method may include the following operation S501 to operation S503.

Operation S501: Receive a subprogram identifier of the target subprogram referencing the media data and the external credential that are transmitted by a subprogram server.

The external credential is acquired by the subprogram server after receiving a subprogram viewing request transmitted by the target subprogram referencing the media data. The subprogram identifier is acquired by the subprogram server from the subprogram viewing request. The subprogram viewing request is transmitted by the target subprogram referencing the media data when responding to a viewing operation for the media data in the target subprogram referencing the media data.

Operation S502: Perform a credential check on the subprogram identifier and the external credential to obtain a credential check result.

Specifically, the media server may decrypt the external credential to obtain a to-be-verified program identifier in the external credential. The external credential is obtained by encrypting the to-be-verified program identifier and the temporary bill. Further, the media server may acquire the control state of the subprogram reference controlling control associated with the media identifier. The subprogram reference controlling control is a control displayed in an interaction management page of the media interaction platform when the publishing object publishing the media data logs in to the media interaction platform. Further, the media server may generate, when the subprogram identifier is the same as the to-be- verified program identifier, and the control state of the subprogram reference controlling control is an on state, the credential check result configured for indicating that the credential check succeeds. The credential check may ensure that the external credential indeed comes from a subprogram development object of the target subprogram, thereby ensuring the security and traceability of the external credential.

In some embodiments, the media server may generate, when the subprogram identifier is the same as the to-be-verified program identifier, the control state of the subprogram reference controlling control is the off state, and the subprogram development object and the publishing object are the same subject object, the credential check result configured for indicating that the credential check succeeds.

In some embodiments, the media server may generate, when the subprogram identifier is different from the to-be-verified program identifier, the credential check result configured for indicating that the credential check fails. When the subprogram identifier is different from the to-be-verified program identifier, the media server may determine that the temporary bill is not generated for the subprogram identifier. In some embodiments, the media server may generate, when the control state of the subprogram reference controlling control is the off state, and the subprogram development object and the publishing object are different subject objects, the credential check result configured for indicating that the credential check fails.

In some embodiments, the media server may generate, when the subprogram identifier is the same as the to-be-verified program identifier, the credential check result configured for indicating that the credential check succeeds. In some embodiments, the media server may generate, when the subprogram identifier is different from the to-be-verified program identifier, the credential check result configured for indicating that the credential check fails.

In some embodiments, the media server may further acquire a media state of the media data when receiving the subprogram identifier and the external credential transmitted by the subprogram server. The media state may include a normal state and a discontinued state. The discontinued state may indicate that the publishing object deletes the published media data. Further, the media server may generate, when the media state is the discontinued state, the credential check result configured for indicating that the credential check fails, and then return a media viewing failure notification to the subprogram server. For example, the media viewing failure notification may be “this video cannot be played”.

Operation S503: Return media information corresponding to the media data to the subprogram server when the credential check result indicates that the credential check succeeds.

The subprogram server is configured to return the media information to the target subprogram referencing the media data. The target subprogram referencing the media data is configured for displaying the media data based on the media information. A specific process of displaying the media data by the target subprogram referencing the media data may refer to the description of operation S302 in the foregoing embodiment corresponding to FIG. 11, and details are not described herein again.

The subprogram server may acquire media content corresponding to the media data from the media server, and then perform, when receiving the media information returned by the media server, subject analysis on the subprogram development object and the publishing object to obtain a subject analysis result. In this way, when the subject analysis result indicates that the subprogram development object and the publishing object are different subject objects, the media content corresponding to the media data does not need to be transmitted to the terminal device, but the media information is transmitted to the terminal device. In this way, the terminal device may transmit, in response to a trigger operation for a media viewing control, a content acquisition request to the subprogram server. In this way, after receiving the content acquisition request transmitted by the terminal device, the subprogram server may transmit the media content corresponding to the media data to the terminal device. In some embodiments, when the subject analysis result indicates that the subprogram development object and the publishing object are the same subject object, the media content corresponding to the media data and the media information are transmitted to the terminal device together. When the subject analysis result indicates that the subprogram development object and the publishing object are different subject objects, the target subprogram referencing the media data does not need to display the media content corresponding to the media data. Before the subprogram server receives the content acquisition request transmitted by the terminal device, the target subprogram referencing the media data cannot use the media content corresponding to the media data. Therefore, the subprogram server does not need to transmit the media content that cannot be used by the to target subprogram the terminal device, thereby saving the network resources.

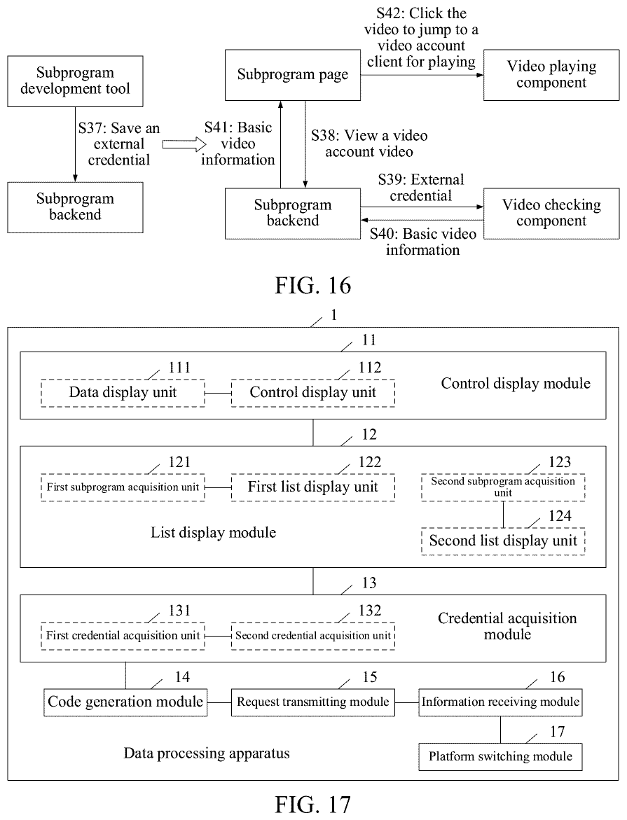

For ease of understanding, FIG. 16 is a schematic flowchart of redeeming an external credential according to an embodiment of this disclosure. As shown in FIG. 16, a specific process of redeeming the external credential may include operation S37 to operation S42. Operation S37 to operation S42 may be subsequent operations of operation S31 to operation S36 in the foregoing embodiment corresponding to FIG. 14. Operation S37 to operation S42 are described using an example in which a media interaction platform is a video interaction platform, media data is video data, and a media server is a video server. The target subprogram may include a subprogram page, the video interaction platform may include a video playing component, the subprogram server may alternatively be referred to as a subprogram backend, and the video server may include a video checking component (i.e., a video account checking component).

As shown in FIG. 16, a subprogram development object may edit subprogram code through a subprogram development tool, and then publish the subprogram code through a subprogram platform. The subprogram platform may transmit the subprogram code to the subprogram backend. In this way, the subprogram backend may save an external credential in the subprogram code transmitted by the subprogram platform through operation S37.

As shown in FIG. 16, an interaction object (for example, the subprogram development object) may open the subprogram page (i.e., opening a target subprogram referencing media data) and view a video account video (i.e., video data) through operation S38 (i.e., performing a viewing operation on the media data in the target subprogram referencing the media data). In this way, the terminal device may transmit, in response to the viewing operation performed by the subprogram development object on the media data in the target subprogram referencing the media data, a subprogram viewing request to the subprogram backend. Further, the subprogram backend may transfer a subprogram identifier and the external credential to the video server through operation S39 (i.e., transferring the subprogram identifier and the external credential to the video server through an intranet interface). In this way, the video server may perform a credential check through the video checking component, and then return, when the credential check succeeds, basic video information (i.e., media information) to the subprogram backend through operation S40.

As shown in FIG. 16, the subprogram backend may return the basic video information to the target subprogram through operation S41. In this way, the target subprogram may display the media data in the subprogram page based on the basic video information. Further, the subprogram development object may perform a trigger operation on the media data in the subprogram page (for example, clicking the video data). In this way, in response to the trigger operation on the media data in the subprogram page, the terminal device may jump to a video account client (i.e., the video interaction platform) through operation S42 (i.e., providing a media jump parameter to the video playing component in the video interaction platform), and acquire complete video playing information (i.e., media content) from a video browsing module through the video playing component, so as to play the video data (i.e., displaying the video data in the video interaction platform).

It can be seen that in this embodiment of this disclosure, the subprogram viewing request transmitted by the target subprogram referencing the media data may be received, the credential check is performed based on the subprogram viewing request, the media information corresponding to the media data is acquired when the credential check succeeds, and the media information is transmitted to the target subprogram referencing the media data so that the target subprogram referencing the media data displays the media data based on the media information, thereby improving the capability of circulating, in the subprogram, the media data in the media interaction platform.

Further, FIG. 17 is a schematic structural diagram of a data processing apparatus according to an embodiment of this disclosure. A data processing apparatus 1 may include: a control display module 11, a list display module 12, and a credential acquisition module 13. Further, the data processing apparatus 1 may further include: a code generation module 14, a request transmitting module 15, an information receiving module 16, and a platform switching module 17.

The control display module 11 is configured to display, when media data and a subprogram development object viewing the media data simultaneously satisfy a media reference condition, a media reference control in a media interaction platform configured for displaying the media data. The media interaction platform is different from a subprogram platform configured for maintaining a subprogram.

The control display module 11 includes: a data display unit 111 and a control display unit 112.

The data display unit 111 is configured to display the media data in the media interaction platform. The media interaction platform includes a media forwarding control.

The control display unit 112 is configured to display, in response to a trigger operation for the media forwarding control, the media reference control in the media interaction platform when the media data and the subprogram development object viewing the media data simultaneously satisfy the media reference condition.

The control display unit 112 is specifically configured to generate, in response to the trigger operation for the media forwarding control, a media forwarding request based on a development object identifier of the subprogram development object and a media identifier of the media data, and transmit the media forwarding request to a media server. The media forwarding request is configured for instructing the media server to perform condition analysis on the development object identifier and the media identifier to obtain a condition analysis result. The media server is configured to return a temporary bill to the media interaction platform when the condition analysis result indicates that the media data and the subprogram development object simultaneously satisfy the media reference condition. The temporary bill is obtained by the media server encrypting the development object identifier and the media identifier.

The control display unit 112 is specifically configured to receive the temporary bill returned by the media server, and display the media reference control in the media interaction platform based on the temporary bill.

Specific implementations of the data display unit 111 and the control display unit 112 may refer to the descriptions of operation S101 in the foregoing embodiment corresponding to FIG. 3 and operation S201 in the foregoing embodiment corresponding to FIG. 9, and details are not described herein again.

The list display module 12 is configured to display, in the media interaction platform, a subprogram selection list associated with the subprogram development object in response to a trigger operation for the media reference control.

The list display module 12 includes: a first subprogram acquisition unit 121, a first list display unit 122, a second subprogram acquisition unit 123, and a second list display unit 124.

The first subprogram acquisition unit 121 is configured to acquire, in response to the trigger operation for the media reference control, subprograms associated with the subprogram development object.

The first list display unit 122 is configured to determine, when there is one subprogram associated with the subprogram development object, the subprogram associated with the subprogram development object as the target subprogram, and display, in the media interaction platform, the subprogram selection list associated with the subprogram development object. The subprogram selection list contains the target subprogram in a default selected state.

The second subprogram acquisition unit 123 is configured to acquire, in response to the trigger operation for the media reference control, subprograms associated with the subprogram development object.

The second list display unit 124 is configured to display, in the media interaction platform, the subprogram selection list associated with the subprogram development object when there are a plurality of subprograms associated with the subprogram development object. The subprogram selection list contains the plurality of subprograms in an unselected state.

Specific implementations of the first subprogram acquisition unit 121, the first list display unit 122, the second subprogram acquisition unit 123, and the second list display unit 124 may refer to the description of operation S102 in the foregoing embodiment corresponding to FIG. 3, and details are not described herein again.

The credential acquisition module 13 is configured to acquire, in response to a confirmation operation for the subprogram selection list, an external credential for the media data. The external credential is configured for instructing the subprogram development object to reference the media data to a target subprogram, and the target subprogram referencing the media data has permission to display the media data. The target subprogram is a subprogram selected by the subprogram development object from the subprogram selection list.

The credential acquisition module includes: a first credential acquisition unit 131 and a second credential acquisition unit 132.

The first credential acquisition unit 131 is configured to display, in the media interaction platform, a selection confirmation control for the target subprogram.

The first credential acquisition unit 131 is configured to acquire, in response to a trigger operation for the selection confirmation control, the external credential for the media data.

The first credential acquisition unit 131 is specifically configured to generate, in response to the trigger operation for the selection confirmation control, a security check request based on the development object identifier of the subprogram development object, a subprogram identifier of the target subprogram, and the temporary bill, and transmit the security check request to the media server. The security check request is configured for instructing the media server to perform a security check on the development object identifier and the temporary bill to obtain a security check result. The media server is configured to return the external credential for the media data to the media interaction platform when the security check result indicates that the security check succeeds. The external credential is obtained by the media server encrypting the subprogram identifier and the temporary bill. The temporary bill is obtained by the media server encrypting the development object identifier and the media identifier of the media data.

The first credential acquisition unit 131 is specifically configured to receive the external credential returned by the media server.

The second credential acquisition unit 132 is configured to determine, in response to a selection operation for the plurality of subprograms in the unselected state in the subprogram selection list, a subprogram selected by the selection operation as the target subprogram, and update and display the target subprogram in the subprogram selection list from the unselected state to a selected state.

The second credential acquisition unit 132 is configured to display a selection confirmation control for the target subprogram in the selected state.

The second credential acquisition unit 132 is configured to acquire, in response to a trigger operation for the selection confirmation control, the external credential for the media data.

Specific implementations of the first credential acquisition unit 131 and the second credential acquisition unit 132 may refer to the descriptions of operation S103 in the foregoing embodiment corresponding to FIG. 3 and operation S203 in the foregoing embodiment corresponding to FIG. 9, and details are not described herein again.

The credential acquisition module 13 is further specifically configured to copy the external credential, and display reference prompt information in the media interaction platform based on the external credential. The reference prompt information is configured for prompting that the media data is referenced to the target subprogram based on the copied external credential.

The data processing apparatus 1 is further specifically configured to display, in the subprogram platform, media reference description information and a media reference controlling control corresponding to the media reference description information. A control state of the media reference controlling control is an off state.

The data processing apparatus 1 is further specifically configured to update and display the media reference controlling control from the off state to an on state in response to a trigger operation for the media reference controlling control. The media reference controlling control in the on state is configured to indicate that the subprogram development object satisfies the media reference condition.

The data processing apparatus 1 is further specifically configured to update and display the media reference controlling control from the on state to the off state again when a default time period is reached.

The media interaction platform is further configured for providing an interaction management page to a publishing object configured for publishing media data. The interaction management page includes subprogram reference description information and a subprogram reference controlling control corresponding to the subprogram reference description information. A control state of the subprogram reference controlling control is an off state. The subprogram reference controlling control is configured for instructing to update and display the subprogram reference controlling control from the off state to an on state when the publishing object performs a trigger operation on the subprogram reference controlling control. The subprogram reference controlling control in the on state is configured for indicating that the media data published by the publishing object satisfies the media reference condition.

In some embodiments, the code generation module 14 is configured to generate, in response to a pasting operation for the copied external credential, subprogram code including the external credential.

The code generation module 14 is configured to display the subprogram code in the subprogram platform, and transmit, in response to a publishing operation for the subprogram code, the subprogram code to a subprogram server. The subprogram server is configured to perform program compiling on the subprogram code to obtain the target subprogram referencing the media data. The target subprogram referencing the media data is configured for instructing the subprogram server to push a media reference notification to a publishing object configured for publishing the media data.

The subprogram server is configured to compare the media data with the media reference condition in the process of performing program compiling on the subprogram code, to obtain a condition comparison result. The subprogram server is further configured to return a program compiling failure notification to the subprogram platform when the condition comparison result indicates that the media data does not satisfy the media reference condition.

The data processing apparatus 1 is further specifically configured to receive the program compiling failure notification returned by the subprogram server and display the program compiling failure notification in the subprogram platform.

In some embodiments, the request transmitting module 15 is configured to generate, in response to a viewing operation for the media data in the target subprogram referencing the media data, a subprogram viewing request based on a subprogram identifier of the target subprogram referencing the media data, and transmit the subprogram viewing request to the subprogram server. The subprogram viewing request is configured for instructing the subprogram server to transmit the subprogram identifier and the external credential to a media server after acquiring the external credential for the media data. The media server is configured to perform a credential check on the subprogram identifier and the external credential to obtain a credential check result. The media server is further configured to return media information corresponding to the media data to the subprogram server when the credential check result indicates that the credential check succeeds. The subprogram server is configured to return the media information to the target subprogram referencing the media data.

The information receiving module 16 is configured to receive the media information returned by the subprogram server, and display, based on the media information, the media data in the target subprogram referencing the media data.

The media information includes a media cover image of the media data.

The information receiving module 16 is specifically configured to display, when the subprogram development object and the publishing object are different subject objects, the media cover image in the target subprogram referencing the media data.

The information receiving module 16 is specifically configured to receive, when the subprogram development object and the publishing object are the same subject object, media content corresponding to the media data transmitted by the subprogram server, and display the media content in the target subprogram referencing the media data.

The platform switching module 17 is configured to switch, in response to a trigger operation for the media data in the target subprogram referencing the media data, the target subprogram referencing the media data to the media interaction platform according to a media jump parameter in the media information, and display the media data in the media interaction platform.

Specific implementations of the control display module 11, the list display module 12, the credential acquisition module 13, the code generation module 14, the request transmitting module 15, the information receiving module 16, and the platform switching module 17 may refer to the descriptions of operation S101 to operation S103 in the foregoing embodiment corresponding to FIG. 3, operation S201 to operation S205 in the foregoing embodiment corresponding to FIG. 9, and operation S301 to operation S303 in the foregoing embodiment corresponding to FIG. 11, and details are not described herein again. In addition, the description of beneficial effects of the same method are not described herein again.

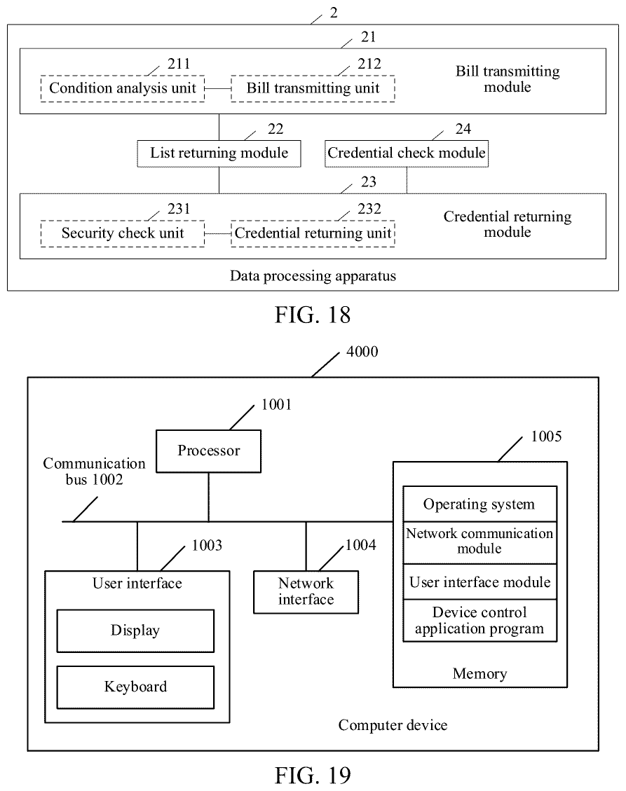

Further, FIG. 18 is a schematic structural diagram of a data processing apparatus according to an embodiment of this disclosure. A data processing apparatus 2 may include: a bill transmitting module 21, a list returning module 22, and a credential returning module 23. Further, the data processing apparatus 2 may further include: a credential check module 24.

The bill transmitting module 21 is configured to transmit, when media data and a subprogram development object viewing the media data simultaneously satisfy a media reference condition, a temporary bill to a media interaction platform configured for displaying the media data. The temporary bill is configured for instructing the media interaction platform to display a media reference control. The media interaction platform is different from a subprogram platform configured for maintaining a subprogram.

The bill transmitting module 21 includes: a condition analysis unit 211 and a bill transmitting unit 212.

The condition analysis unit 211 is configured to receive a media forwarding request transmitted by the media interaction platform configured for displaying the media data, and acquire, from the media forwarding request, a development object identifier of the subprogram development object viewing the media data and a media identifier of the media data.

The condition analysis unit 211 is configured to perform condition analysis on the development object identifier and the media identifier to obtain a condition analysis result.

The condition analysis unit 211 is specifically configured to acquire a control state of a media reference controlling control associated with the development object identifier, and acquire a control state of a subprogram reference controlling control associated with the media identifier. The media reference controlling control is a control displayed in the subprogram platform when the subprogram development object logs in to the subprogram platform. The subprogram reference controlling control is a control displayed in an interaction management page of the media interaction platform when a publishing object publishing the media data logs in to the media interaction platform.

The condition analysis unit 211 is specifically configured to perform media review on the media data corresponding to the media identifier to generate a media review result corresponding to the media data.

The condition analysis unit 211 is specifically configured to generate, when the control state of the media reference controlling control is an on state, the control state of the subprogram reference controlling control is an on state, and the media review result indicates that the media review succeeds, the condition analysis result configured for indicating that the media data and the subprogram development object simultaneously satisfy the media reference condition.

The bill transmitting unit 212 is configured to encrypt, when the condition analysis result indicates that the media data and the subprogram development object simultaneously satisfy the media reference condition, the development object identifier and the media identifier to obtain the temporary bill.

The bill transmitting unit 212 is configured to transmit the temporary bill to the media interaction platform.

Specific implementations of the condition analysis unit 211 and the bill transmitting unit 212 may refer to the descriptions of operation S401 in the foregoing embodiment corresponding to FIG. 13, and details are not described herein again.

The list returning module 22 is configured to receive a list acquisition request transmitted by the media interaction platform, and return a subprogram selection list associated with the subprogram development object to the media interaction platform based on the list acquisition request. The list acquisition request is transmitted by the media interaction platform when responding to a trigger operation for the media reference control.

The credential returning module 23 is configured to receive a security check request transmitted by the media interaction platform, and return an external credential for the media data to the media interaction platform based on the security check request. The security check request is transmitted by the media interaction platform when responding to a confirmation operation for a target subprogram in the subprogram selection list. The external credential is configured for instructing the subprogram development object to reference the media data to a target subprogram, and the target subprogram referencing the media data has permission to display the media data.

The credential returning module 23 includes: a security check unit 231 and a credential returning unit 232.

The security check unit 231 is configured to receive the security check request transmitted by the media interaction platform, and acquire a development object identifier of the subprogram development object, a subprogram identifier of the target subprogram, and the temporary bill from the security check request.

The security check unit 231 is configured to perform a security check on the development object identifier and the temporary bill to obtain a security check result.

The security check unit 231 is specifically configured to decrypt the temporary bill to obtain a to-be-verified object identifier in the temporary bill and a media identifier of the media data. The temporary bill is obtained by encrypting the to-be-verified object identifier and the media identifier of the media data.

The security check unit 231 is specifically configured to acquire the number of external credentials acquired by the subprogram development object corresponding to the development object identifier in a target time period.

The security check unit 231 is specifically configured to acquire a control state of a subprogram reference controlling control associated with a media identifier. The subprogram reference controlling control is a control displayed in an interaction management page of the media interaction platform when a publishing object publishing the media data logs in to the media interaction platform.

The security check unit 231 is specifically configured to generate, when the development object identifier is the same as the to-be-verified object identifier, the number of credentials is less than a quantity threshold, and the control state of the subprogram reference controlling control is an on state, the security check result configured for indicating that the security check succeeds.

The credential returning unit 232 is configured to encrypt, when the security check result indicates that the security check succeeds, the subprogram identifier and the temporary bill to obtain the external credential for the media data.

The credential returning unit 232 is configured to return the external credential to the media interaction platform.

Specific implementations of the security check unit 231 and the credential returning unit 232 may refer to the descriptions of operation S403 in the foregoing embodiment corresponding to FIG. 13, and details are not described herein again.

In some embodiments, the credential check module 24 is configured to receive a subprogram identifier of the target subprogram referencing the media data and the external credential that are transmitted by a subprogram server. The external credential is acquired by the subprogram server after receiving a subprogram viewing request transmitted by the target subprogram referencing the media data. The subprogram identifier is acquired by the subprogram server from the subprogram viewing request. The subprogram viewing request is transmitted by the target subprogram referencing the media data when responding to a viewing operation for the media data in the target subprogram referencing the media data.

The credential check module 24 is configured to perform a credential check on the subprogram identifier and the external credential to obtain a credential check result.

The credential check module 24 is specifically configured to decrypt the external credential to obtain a to-be-verified program identifier in the external credential. The external credential is obtained by encrypting the to-be-verified program identifier and the temporary bill.

The credential check module 24 is specifically configured to acquire a control state of a subprogram reference controlling control associated with a media identifier. The subprogram reference controlling control is a control displayed in an interaction management page of the media interaction platform when a publishing object publishing the media data logs in to the media interaction platform.

The credential check module 24 is specifically configured to generate, when the subprogram identifier is the same as the to-be-verified program identifier, and the control state of the subprogram reference controlling control is an on state, the credential check result configured for indicating that the credential check succeeds.

The credential check module 24 is configured to return media information corresponding to the media data to the subprogram server when the credential check result indicates that the credential check succeeds. The subprogram server is configured to return the media information to the target subprogram referencing the media data. The target subprogram referencing the media data is configured for displaying the media data based on the media information.

Specific implementations of the bill transmitting module 21, the list returning module 22, the credential returning module 23, and the credential check module 24 may refer to the descriptions of operation S401 to operation S403 in the foregoing embodiment corresponding to FIG. 13 and operation S501 to operation S503 in the foregoing embodiment corresponding to FIG. 15, and details are not described herein again. In addition, the description of beneficial effects of the same method are not described herein again.

Further, FIG. 19 is a schematic structural diagram of a computer device according to an embodiment of this disclosure. The computer device may be a terminal device or a media server. As shown in FIG. 19, a computer device 4000 may include: a processor 1001, a network interface 1004, and a memory 1005. In addition, the foregoing computer device 4000 may further include: a user interface 1003 and at least one communication bus 1002. The communication bus 1002 is configured to implement the connection and communication among the components. In some embodiments, the user interface 1003 may include a display and a keyboard. In some embodiments, the user interface 1003 may further include a standard wired interface and a standard wireless interface. In some embodiments, the network interface 1004 may include a standard wired interface and a standard wireless interface (such as a WI-FI interface). The memory 1005 may be a high-speed random access memory (RAM), or may be a non-volatile memory, for example, at least one magnetic disk storage. In some embodiments, the memory 1005 may further be at least one storage apparatus that is located far away from the foregoing processor 1001. As shown in FIG. 19, as a computer-readable storage medium, the memory 1005 may include an operating system, a network communication module, a user interface module, and a device control application program.

In the computer device 4000 shown in FIG. 19, the network interface 1004 may provide a network communication function. The user interface 1003 is mainly configured to provide an input interface for a user. The processor 1001 may be configured to invoke the device control application program stored in the memory 1005.

The computer device 4000 described in this embodiment of this disclosure may perform the descriptions of the data processing method in the foregoing embodiments corresponding to FIG. 3, FIG. 9, FIG. 11, FIG. 13, or FIG. 15, or may perform the descriptions of the data processing apparatus 1 in the foregoing embodiment corresponding to FIG. 17 and the data processing apparatus 2 in the foregoing embodiment corresponding to FIG. 18, and details are not described herein again. In addition, the description of beneficial effects of the same method are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In addition, the embodiments of this disclosure further provide a computer-readable storage medium, having a computer program executed by the foregoing data processing apparatus 1 or the foregoing data processing apparatus 2 stored therein. When executing the computer program, a processor can perform the descriptions of the data processing method in the foregoing embodiments corresponding to FIG. 3, FIG. 9, FIG. 11, FIG. 13, or FIG. 15. Therefore, details are not described herein again. In addition, the description of beneficial effects of the same method are not described herein again. Technical details that are not disclosed in the computer-readable storage medium embodiment of this disclosure may refer to the descriptions of the method embodiments of this disclosure.

In addition, the embodiments of this disclosure further provide a computer program product. The computer program product may include a computer program, and the computer program may be stored in a computer-readable storage medium. A processor of a computer device reads the computer program from the computer-readable storage medium, and the processor may execute the computer program to cause the computer device to perform the descriptions of the data processing method in the foregoing embodiments corresponding to FIG. 3, FIG. 9, FIG. 11, FIG. 13, or FIG. 15. Therefore, details are not described herein again. In addition, the description of beneficial effects of the same method are not described herein again. Technical details that are not disclosed in the computer program product embodiment of this disclosure may refer to the descriptions of the method embodiments of this disclosure.

A person skilled in the art may understand that all or some of the procedures in the methods of the foregoing embodiments may be accomplished by instructing the relevant hardware through the computer program. The computer program may be stored on a computer-readable storage medium and may include the procedures of the foregoing method embodiments when executed. The storage medium may be a magnetic disk, an optical disc, a read-only memory (ROM), a RAM, or the like.

What is disclosed above is merely example embodiments of this disclosure, and certainly is not intended to limit the scope of the claims of this disclosure. Therefore, equivalent variations made in accordance with the aspects of this disclosure shall fall within the scope of this disclosure.

What is claimed is:

1. A data processing method, comprising:
displaying, when media data and a user viewing the media data simultaneously satisfy a media reference condition, a media reference control in a media interaction platform configured to display the media data and different from a subprogram platform configured to maintain a subprogram;
displaying, in the media interaction platform, a subprogram selection list associated with the user based on a trigger operation on the media reference control; and
obtaining, based on the user performing a confirmation operation with the subprogram selection list, an external credential for the media data that is configured for the user to reference the media data to a target subprogram that has permission to display the media data.

2. The method according to claim 1, wherein the displaying the media reference control comprises:
displaying the media data in the media interaction platform; and
displaying, in response to a trigger operation on a media forwarding control, the media reference control in the media interaction platform when the media data and the user viewing the media data simultaneously satisfy the media reference condition.

3. The method according to claim 1, wherein the displaying the subprogram selection list comprises:
determining, in response to the trigger operation on the media reference control, subprograms associated with the user;
determining, when there is one subprogram associated with the user, the subprogram associated with the user as the target subprogram;
displaying, in the media interaction platform, the subprogram selection list including the target subprogram in a default selected state; and
the obtaining the external credential for the media data comprises:
displaying, in the media interaction platform, a selection confirmation control for the target subprogram; and
obtaining, in response to a trigger operation on the selection confirmation control, the external credential for the media data.

4. The method according to claim 1, wherein the displaying the subprogram selection list comprises:
determining, in response to the trigger operation on the media reference control, subprograms associated with the user; and
displaying, in the media interaction platform, the subprogram selection list associated with the user when there is a plurality of subprograms associated with the user, the subprogram selection list including the plurality of subprograms in an unselected state; and
the obtaining the external credential for the media data comprises:
determining, in response to a selection operation on the plurality of subprograms in the unselected state in the subprogram selection list, a subprogram selected by the selection operation as the target subprogram;
updating and displaying the target subprogram in the subprogram selection list from the unselected state to a selected state;
displaying a selection confirmation control for the target subprogram in the selected state; and
obtaining, in response to a trigger operation on the selection confirmation control, the external credential for the media data.

5. The method according to claim 2, wherein the displaying the media reference control comprises:
generating, in response to the trigger operation on the media forwarding control, a media forwarding request based on a development object identifier of the user and a media identifier of the media data;
transmitting the media forwarding request to a media server, wherein the media forwarding request instructs the media server to obtain a condition analysis result based on condition analysis on the development object identifier and the media identifier, the media server configured to return a temporary bill to the media interaction platform when the condition analysis result indicates that the media data and the user simultaneously satisfy the media reference condition, and the temporary bill is obtained by the media server encrypting the development object identifier and the media identifier;
receiving the temporary bill returned by the media server; and
displaying the media reference control in the media interaction platform based on the temporary bill.

6. The method according to claim 5, wherein the obtaining the external credential for the media data comprises:
generating, in response to a trigger operation on a selection confirmation control, a security check request based on the development object identifier of the user, a subprogram identifier of the target subprogram, and the temporary bill;
transmitting the security check request to the media server, wherein the security check request instructs the media server to perform a security check on the development object identifier and the temporary bill to obtain a security check result, the media server is configured to return the external credential for the media data to the media interaction platform when the security check result indicates that the security check succeeded, the external credential is obtained by the media server encrypting the subprogram identifier and the temporary bill, and the temporary bill is obtained by the media server encrypting the development object identifier and the media identifier of the media data; and
receiving the external credential returned by the media server.

7. The method according to claim 1, comprising:
copying the external credential, and displaying reference prompt information in the media interaction platform based on the external credential, the reference prompt information configured to prompt that the media data is referenced to the target subprogram based on the copied external credential;
generating, in response to a pasting operation on the copied external credential, subprogram code including the external credential;
displaying the subprogram code in the subprogram platform; and
transmitting, in response to a publishing operation on the subprogram code, the subprogram code to a subprogram server, the subprogram server configured to perform program compiling on the subprogram code to obtain the target subprogram referencing the media data, and the target subprogram referencing the media data configured to instruct the subprogram server to push a media reference notification to a publishing object configured to publish the media data.

8. The method according to claim 7, comprising:
generating, in response to a viewing operation on the media data in the target subprogram referencing the media data, a subprogram viewing request based on a subprogram identifier of the target subprogram referencing the media data;
transmitting the subprogram viewing request to the subprogram server, wherein the subprogram viewing request instructs the subprogram server to transmit the subprogram identifier and the external credential to a media server based on acquiring the external credential for the media data, the media server is configured to perform a credential check on the subprogram identifier and the external credential to obtain a credential check result, the media server is further configured to return media information corresponding to the media data to the subprogram server when the credential check result indicates that the credential check succeeded, and the subprogram server is configured to return the media information to the target subprogram referencing the media data;
receiving the media information returned by the subprogram server;
displaying, based on the media information, the media data in the target subprogram referencing the media data;
switching, in response to a trigger operation on the media data in the target subprogram referencing the media data, the target subprogram referencing the media data to the media interaction platform according to a media jump parameter in the media information; and
displaying the media data in the media interaction platform.

9. A data processing method comprising:
transmitting, when media data and a user viewing the media data simultaneously satisfy a media reference condition, a temporary bill to a media interaction platform configured to display the media data and different from a subprogram platform configured to maintain a subprogram, the temporary bill configured to instruct the media interaction platform to display a media reference control;
receiving a list acquisition request transmitted by the media interaction platform in response to a trigger operation on the media reference control, and returning a subprogram selection list associated with the user to the media interaction platform based on the list acquisition request; and
receiving a security check request transmitted by the media interaction platform in response to a confirmation operation on a target subprogram in the subprogram selection list, and returning an external credential for the media data to the media interaction platform based on the security check request, the external credential configured to instruct the user to reference the media data to the target subprogram that has permission to display the media data.

10. The method according to claim 9, wherein the transmitting the temporary bill comprises:
receiving a media forwarding request transmitted by the media interaction platform configured to display the media data, and obtaining, from the media forwarding request, a development object identifier of the user viewing the media data and a media identifier of the media data;
obtaining a condition analysis result based on performing condition analysis on the development object identifier and the media identifier;
obtain the temporary bill based on encrypting, when the condition analysis result indicates that the media data and the user simultaneously satisfy the media reference condition, the development object identifier and the media identifier; and
transmitting the temporary bill to the media interaction platform.

11. The method according to claim 10, wherein the performing the condition analysis comprises:
obtaining a control state of a media reference control associated with the development object identifier, and obtaining a control state of a subprogram reference control associated with the media identifier, the media reference control being a control displayed in the subprogram platform when the user logs in to the subprogram platform; and the subprogram reference control being a control displayed in an interaction management page of the media interaction platform when a publishing object that publishes the media data logs in to the media interaction platform;
performing media review on the media data corresponding to the media identifier to generate a media review result corresponding to the media data; and
generating, when the control state of the media reference control is in an on state, the control state of the subprogram reference control is in an on state, and the media review result indicates that the media review succeeded, the condition analysis result indicating that the media data and the user simultaneously satisfy the media reference condition.

12. The method according to claim 9, wherein the receiving the security check request and the returning the external credential for the media data comprises:
receiving the security check request transmitted by the media interaction platform, and obtaining a development object identifier of the user, a subprogram identifier of the target subprogram, and the temporary bill from the security check request;
obtaining a security check result based on performing a security check on the development object identifier and the temporary bill;
obtaining the external credential for the media data based on encrypting, when the security check result indicates that the security check succeeded, the subprogram identifier and the temporary bill; and
returning the external credential to the media interaction platform.

13. The method according to claim 12, wherein the obtaining the security check result comprises:
obtaining a to-be-verified object identifier in the temporary bill and a media identifier of the media data based on decrypting the temporary bill, the temporary bill being obtained by encrypting the to-be-verified object identifier and the media identifier of the media data;
acquiring a number of external credentials acquired by the user corresponding to the development object identifier in a target time period;
acquiring a control state of a subprogram reference control associated with the media identifier, the subprogram reference control including a control displayed in an interaction management page of the media interaction platform when a publishing object that publishes the media data logs in to the media interaction platform; and
generating, when the development object identifier is the same as the to-be-verified object identifier, the number of credentials is less than a quantity threshold, and the control state of the subprogram reference control is in an on state, the security check result indicating that the security check succeeded.

14. The method according to claim 9, comprising:
receiving a subprogram identifier of the target subprogram referencing the media data and the external credential from a subprogram server, wherein the external credential is acquired by the subprogram server based on receiving a subprogram viewing request transmitted by the target subprogram referencing the media data, the subprogram identifier is acquired by the subprogram server from the subprogram viewing request, and the subprogram viewing request is transmitted by the target subprogram referencing the media data when responding to a viewing operation on the media data in the target subprogram referencing the media data;
obtaining a credential check result based on performing a credential check on the subprogram identifier and the external credential; and
returning media information corresponding to the media data to the subprogram server when the credential check result indicates that the credential check succeeded, wherein the subprogram server is configured to return the media information to the target subprogram referencing the media data, and the target subprogram referencing the media data is configured to display the media data based on the media information.

15. The method according to claim 14, wherein the obtaining the credential check result comprises:
obtaining a to-be-verified program identifier in the external credential based on decrypting the external credential, the external credential being obtained by encrypting the to-be-verified program identifier and the temporary bill;
obtaining a control state of a subprogram reference control associated with a media identifier, the subprogram reference control being a control displayed in an interaction management page of the media interaction platform when a publishing object that publishes the media data logs in to the media interaction platform; and
generating, when the subprogram identifier is the same as the to-be-verified program identifier, and the control state of the subprogram reference control is an on state, the credential check result indicating that the credential check succeeded.

16. A data processing apparatus comprising:
processing circuitry configured to:
display, when media data and a user viewing the media data simultaneously satisfy a media reference condition, a media reference control in a media interaction platform configured to display the media data and different from a subprogram platform configured to maintain a subprogram;
display, in the media interaction platform, a subprogram selection list associated with the user based on a trigger operation on the media reference control; and
obtain, based on the user performing a confirmation operation with the subprogram selection list, an external credential for the media data that is configured for the user to reference the media data to a target subprogram that has permission to display the media data.

17. The data processing apparatus according to claim 16, wherein the processing circuitry is configured to:
display the media data in the media interaction platform; and
display, in response to a trigger operation on a media forwarding control, the media reference control in the media interaction platform when the media data and the user viewing the media data simultaneously satisfy the media reference condition.

18. The data processing apparatus according to claim 16, wherein the processing circuitry is configured to:
determine, in response to the trigger operation on the media reference control, subprograms associated with the user;
determine, when there is one subprogram associated with the user, the subprogram associated with the user as the target subprogram;
display, in the media interaction platform, the subprogram selection list including the target subprogram in a default selected state;
display, in the media interaction platform, a selection confirmation control for the target subprogram; and
obtain, in response to a trigger operation on the selection confirmation control, the external credential for the media data.

19. The data processing apparatus according to claim 16, wherein the processing circuitry is configured to:
determine, in response to the trigger operation on the media reference control, subprograms associated with the user;
display, in the media interaction platform, the subprogram selection list associated with the user when there is a plurality of subprograms associated with the user, the subprogram selection list including the plurality of subprograms in an unselected state;
determine, in response to a selection operation on the plurality of subprograms in the unselected state in the subprogram selection list, a subprogram selected by the selection operation as the target subprogram;
update and display the target subprogram in the subprogram selection list from the unselected state to a selected state;
display a selection confirmation control for the target subprogram in the selected state; and
obtain, in response to a trigger operation on the selection confirmation control, the external credential for the media data.

20. The data processing apparatus according to claim 17, wherein the processing circuitry is configured to:
generate, in response to the trigger operation on the media forwarding control, a media forwarding request based on a development object identifier of the user and a media identifier of the media data;
transmit the media forwarding request to a media server, wherein the media forwarding request instructs the media server to obtain a condition analysis result based on condition analysis on the development object identifier and the media identifier, the media server configured to return a temporary bill to the media interaction platform when the condition analysis result indicates that the media data and the user simultaneously satisfy the media reference condition, and the temporary bill is obtained by the media server encrypting the development object identifier and the media identifier;
receive the temporary bill returned by the media server; and
display the media reference control in the media interaction platform based on the temporary bill.
